(19) United States
(12) Patent Application Publication
(10) Pub. No.: US 2015/0142491 A1
(43) Pub. Date: May 21, 2015

(54) MANAGEMENT OF FIELD-BASED WORKERS

(71) Applicant: COGNITO LIMITED, Newbury (GB)

(72) Inventor: David Martyn WEBB, Bromsgrove (GB)

(21) Appl. No.: 14/286,558

(22) Filed: May 23, 2014

(30) Foreign Application Priority Data
Nov. 15, 2013 (GB) 1320189.2

(51) Int. Cl. G06Q 10/06

(52) U.S. Cl. CPC G06Q 10/06398; G06Q 10/063114
USPC 705/7.15

(57) ABSTRACT

Systems and methods for managing task-driven field-based workers are described. In an embodiment, a distributed system comprises a component running on a mobile device which displays an activity-based workflow to a user. At transition points in the workflow, one or more activity transactions are transmitted from the mobile device to an Activity Processing Engine. A transaction may comprise: a start time, a start location, an end time, an end location and an activity code, although for a ‘start activity’ transaction, the fields relating to the end of the activity will be null/absent. The Activity Processing Engine analyses the data to generate task-based milestones and behavioural scores for the field-based worker, which may be aggregated over multiple shifts. The detailed information about the activities on shift and the behavioural scores are presented in a graphical user interface which provides objective data about how a worker goes about completing their tasks.

### BACKGROUND

Field-based workers, such as service engineers who repair, service or otherwise maintain equipment such as domestic appliances or heating systems, or industrial equipment, work remotely and in many different locations and often have infrequent face to face contact with their central office and manager. Tasks (i.e. the job e.g. where to go and what to do) are given to a field-based worker (e.g. go to a particular address and fix their central heating boiler) who then reports back when the task has been completed and this report may include details of how long the task took (e.g. two hours) and the outcome (e.g. boiler fixed, new spare part required, unable to fix boiler, etc.).

The embodiments described below are not limited to implementations which solve any or all of the disadvantages of known systems for managing field-based workers.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Systems and methods for managing task-driven field-based workers are described. In an embodiment, a distributed system comprises a component running on a mobile device which displays an activity-based workflow to a user. At transition points in the workflow, one or more activity transactions are transmitted from the mobile device to an Activity Processing Engine. A transaction may comprise: a start time, a start location, an end time, an end location and an activity code, although for a ‘start activity’ transaction, the fields relating to the end of the activity will be null/absent. The Activity Processing Engine analyses the data to generate task-based milestones and behavioral scores for the field-based worker, which may be aggregated over multiple shifts. The detailed information about the activities on shift and the behavioral scores are presented in a graphical user interface which provides objective data about how a worker goes about completing their tasks.

A first aspect provides a system for managing field-based workers comprising: a component running on a mobile device and arranged to present an activity-based workflow to a field-based worker and to transmit one or more activity transactions to an activity processing engine at a transition point in the workflow, an activity transaction including at least one of a start and end time, at least one of a start and end location data, and an activity code; an activity processing engine arranged to receive activity transactions from the mobile device and to process the transactions to generate one or more milestones and to analyze data received to generate one or more behavioral scores, wherein the activity processing engine is further arranged to generate a graphical user interface which presents the behavioral scores for a particular shift performed by a field-based worker along with aggregated scores for a plurality of shifts.

A second aspect provides a method of managing field-based workers comprising: receiving a plurality of activity transactions at an activity processing engine from a mobile device, the generation of activity transactions being triggered by a transition point in an activity-based workflow and an activity transaction including at least one of a start and end time, at least one of a start and end location data, and an activity code; processing the transactions to generate one or more milestones; analyzing the transactions to generate one or more behavioral scores; and generating a graphical user interface comprising the behavioral scores for a particular shift performed by a field-based worker and aggregated scores for a plurality of shifts.

A third aspect provides a system for managing field-based workers comprising: an activity processing engine arranged to receive activity transactions from a mobile device and to process the transactions to generate one or more milestones and to analyze data received to generate one or more behavioral scores, wherein the generation of activity transactions is triggered by a transition point in an activity-based workflow and an activity transaction includes at least one of a start and end time, at least one of a start and end location data, and an activity code; wherein the activity processing engine is further arranged to generate a graphical user interface which presents the behavioral scores for a particular shift performed by a field-based worker along with aggregated scores for a plurality of shifts in a single screen.

The method may further comprise: presenting an activity-based workflow to a field-based worker on a mobile device; and transmitting one or more activity transactions from the mobile device to the activity processing engine at a transition point in the workflow.

Further aspects provide an activity processing engine substantially as described with reference to FIG. 1 of the drawings, a component adapted to run on a mobile device, the component being substantially as described with reference to FIG. 2 of the drawings, and a system substantially as described with reference to FIG. 1 of the drawings.

The methods described herein may be performed by software in machine readable form on a tangible storage medium e.g. in the form of a computer program comprising computer program code means adapted to perform all the steps of any of the methods described herein when the program is run on a computer and where the computer program may be embodied on a computer readable medium. Examples of tangible (or non-transitory) storage media include disks, thumb drives, memory cards etc. and do not include propagated signals. The software can be suitable for execution on a parallel processor or a serial processor such that the method steps may be carried out in any suitable order, or simultaneously.

This acknowledges that firmware and software can be valuable, separately tradable commodities. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

The preferred features may be combined as appropriate, as would be apparent to a skilled person, and may be combined with any of the aspects of the invention.

### BRIEF DESCRIPTION OF THE DRAWINGS

Embodiments of the invention will be described, by way of example, with reference to the following drawings, in which:

FIG. 1 is a schematic diagram of a distributed system which enables improved assessment of field-based workers;

FIG. 2 is a schematic diagram showing the operation of a component running on the mobile device shown in FIG. 1 and the communication of data from the mobile device to the Activity Processing Engine shown in FIG. 1;

FIG. 3 shows an example of a field-worker's score card;

FIG. 4 illustrates various components of an exemplary computing-based device in which embodiments of the methods described above may be implemented;

FIG. 5 shows a part of an example field-worker's score card in more detail;

FIG. 6 shows various parts of an example field-worker's score card in more detail;

FIG. 7 shows a part of an example field-worker's score card in more detail;

FIG. 8 shows a part of an example field-worker's score card in more detail;

FIG. 9 shows a part of an example field-worker's score card in more detail;

FIG. 10 is a schematic diagram showing various components of an exemplary mobile device;

FIG. 11 is a schematic diagram of an example Activity Processing Engine;

FIG. 12 is a schematic diagram of part of another example Activity Processing Engine;

FIG. 13 is a schematic diagram of part of another example Activity Processing Engine;

FIG. 14 is a schematic diagram of part of another example Activity Processing Engine;

FIG. 15 shows another example screen within a graphical user interface generated by the Activity Processing Engine;

FIG. 16 shows another example screen within a graphical user interface generated by the Activity Processing Engine;

FIG. 17 shows another example screen within a graphical user interface generated by the Activity Processing Engine;

FIG. 18 shows another example screen within a graphical user interface generated by the Activity Processing Engine;

FIG. 19 shows another example screen within a graphical user interface generated by the Activity Processing Engine;

FIG. 20 shows another example screen within a graphical user interface generated by the Activity Processing Engine; and

FIG. 21 shows another example screen within a graphical user interface generated by the Activity Processing Engine.

Common reference numerals are used throughout the figures to indicate similar features.

### DETAILED DESCRIPTION

Embodiments of the present invention are described below by way of example only. These examples represent the best ways of putting the invention into practice that are currently known to the Applicant although they are not the only ways in which this could be achieved. The description sets forth the functions of the example and the sequence of steps for constructing and operating the example. However, the same or equivalent functions and sequences may be accomplished by different examples.

Task-driven field-based workers work remotely (i.e. away from the central office where their managers work) and in many different locations to perform repeated numbers of tasks (or jobs). Examples of task-driven field-based workers (or field-workers) include, but are not limited to, service/maintenance/repair engineers (e.g. for domestic or industrial equipment), delivery workers (e.g. parcel delivery drivers) and taxi/minicab/chauffeur drivers. In each of these examples, the field-based workers perform many tasks which are similar (e.g. fix appliance, deliver parcel, drive passenger from A to B, etc.) and these tasks are distributed and managed from the central office (or central management organization). As a result of being field-based, the workers often have infrequent face to face contact with their manager, unlike office-based workers. Task-driven field-based workers are also distinct from home-based workers, as the home-based workers are not task-driven, work in a single location and are often connected in directly to the office-based systems so that their home office may be considered an extension of the office environment.

Tasks (or jobs) are given to a task-driven field-based worker who then reports back when the task has been completed and this report may include details of how long the task took and the outcome. The field-based worker may then be provided with a next task or alternatively the field-based worker may be given a list of tasks to complete in a particular period (e.g. a task list for a day/shift). The tasks are often subject to demanding service level agreements and there is a need for both operational effectiveness (i.e. how well the tasks are done) and overall efficiency and cost control.

In the following description the terms ‘day’ and ‘shift’ may be used interchangeably to refer to a single period that the task-driven field-based worker is working. It will be appreciated that task-driven field-based workers may have different working patterns (e.g. such that they work days, nights or any shift pattern).

The lack of contact between a task-driven field-worker and their manager makes managing that worker more difficult. The only information on which the manager can assess the worker is the milestones associated with each task which have been reported back by the worker. These milestones, however, provide information on the work being done but do not provide good information about the quality and/or consistency of the task-driven field-based worker themselves. The field-worker may, in some examples, also be required to complete a time-sheet which indicates the number of hours worked, but again this does not provide good information about the quality/consistency of a worker. In some examples, 40% of the time of a worker may not be task based and so is unaccounted for in a task-driven system.

Systems and methods are described herein which enable improved assessment of task-driven field-based workers (which may be referred to as ‘workers’ in the following description) by capturing how a task-driven field-based worker goes about their work (e.g. the sequence, timing and location of the activities they undertake). The systems and methods provide detailed objective information which allows a manager to assess the quality of a worker (e.g. their overall performance) and may enable them to identify areas where additional training or management guidance/support is required. As is described in more detail below, instead of being centered around tasks (as with known systems), the systems and methods described herein are centered around the activities of the task-driven field-based worker. Data is captured (in real-time) at many different points during a shift about the activities of the worker and from this data the traditional service delivery milestones can be computed. In addition, however, the activity information may be used to present an employee performance management graphical user interface (GUI) or “Field-worker score card” which provides an overview of the field-worker's performance in a single screen. Further detail may be provided through selection of elements (e.g. clicking on controls) within the single screen. Additionally the GUI may provide other data, such as a series of further single screen presentations which each represent a different view (or perspective) of the business activity and many of which provide real-time information.

The term ‘task’ or ‘job’ is used herein to refer to the high level operation that a task-driven field-based worker performs repeatedly, e.g. repair equipment, take passenger to required destination, deliver parcel, etc. and the terms ‘task’ and ‘job’ may be used interchangeably. Typically a field-based worker will perform a finite range of tasks (e.g. 50 different tasks).

In contrast, the term ‘activity’ is used herein to refer to a particular action being performed by the worker (at a much lower level of granularity than the task) which makes up part of a worker's day (or shift). A sequence of activities enable a task to be performed (e.g. travel to task location, transition within premises to site of equipment, perform health and safety check, repair equipment, transition back to vehicle, complete paperwork, etc.) but there may also be non-task related activities (e.g. a daily vehicle check, lunch break, etc.).

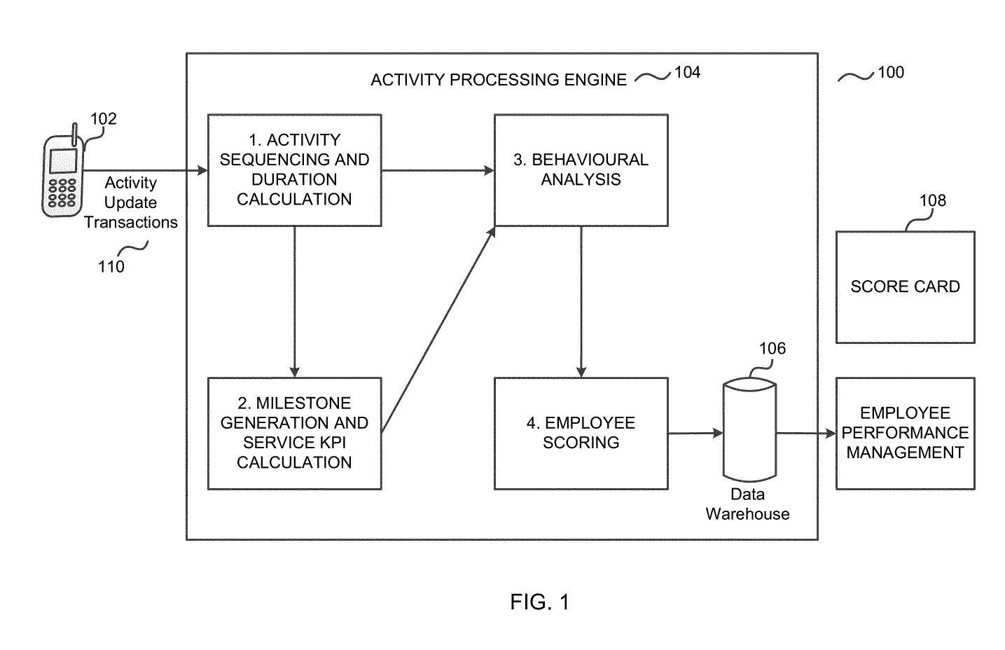

FIG. 1 is a schematic diagram of a distributed (cross-platform) system 100 which enables improved assessment of field-based workers. As the workers are field-based and information is captured in real-time the system is distributed with a component running on a mobile device 102 which is carried by the field-worker. It will be appreciated that the mobile device 102 may have many different forms and may, for example, be a mobile telephone (e.g. a smartphone), a tablet computer, laptop computer, PDA (personal digital assistant) or a proprietary device (e.g. the component may run on service equipment used by the field-worker).

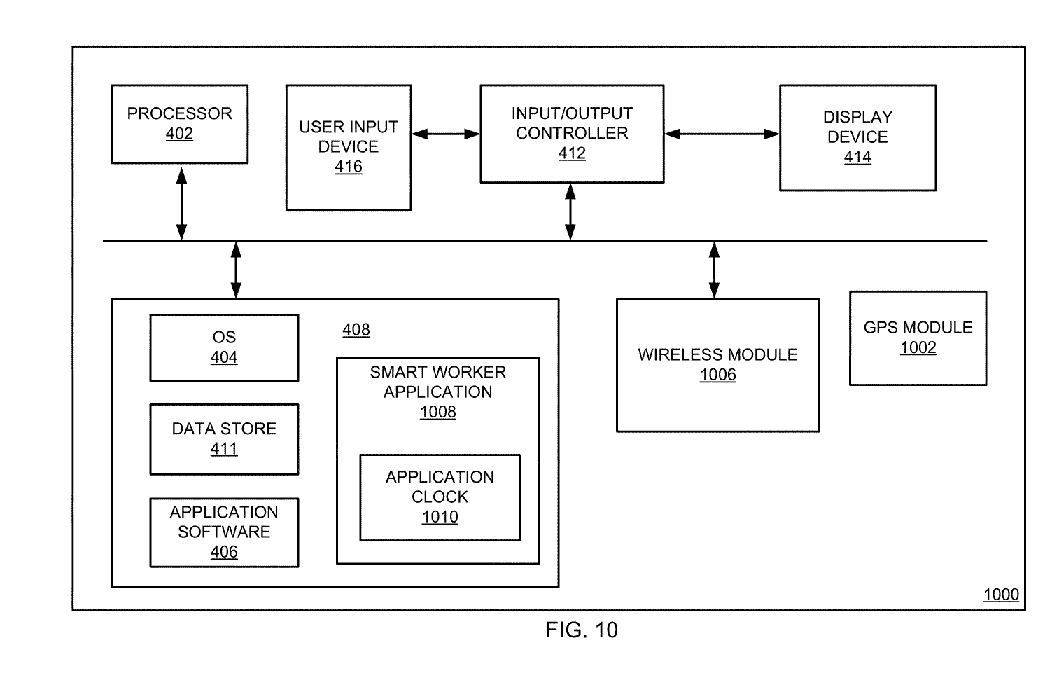

In various examples, the component running on the mobile device 102 is a hybrid mobile application (or ‘hybrid-app’) which, like a native application, runs on the mobile device 102 but is written with web technologies and uses the device's browser engine (but not the browser) to render the graphical user interface (e.g. the HTML) locally. This is distinct from a mobile web application which is a server-side application. By using a hybrid mobile application rather than a mobile web application, the component has access to device capabilities (e.g. the GPS module, camera, local storage within the mobile device) via a native programming layer and this also enables use of a time stamp which is separate from the user modifiable date and time on the device (as described in more detail below). An example implementation of the component running on the mobile device 102 is described below with reference to FIG. 10.

The system 100 further comprises an Activity Processing Engine 104 which runs remotely from the mobile device 102 and, although only a single mobile device 102 is shown in FIG. 1, the Activity Processing Engine 104 communicates with and receives data from a plurality of mobile devices 102. In an example, the Activity Processing Engine 104 may receive data from tens, hundreds or even thousands of mobile devices 102, with each mobile device 102 being associated with a different field-based worker. As is described in more detail below, the Activity Processing Engine 104 (which may comprise computer-executable instructions running on a server) receives and stores the data received in a data store (or data warehouse) 106 which may be co-located with or remote from the Activity Processing Engine 104. The Activity Processing Engine 104 also analyses and manipulates the data received (e.g. to compute the traditional task-centered milestones) and generates a GUI 108 which displays performance management information for the field-based workers. This GUI 108 may be displayed on a computing-device which is co-located with the Activity Processing Engine 104 or the GUI 108 may be displayed on a remote computing device (e.g. where the Activity Processing Engine 104 does not run in the central office or where the field-based worker's manager is not based in the central office).

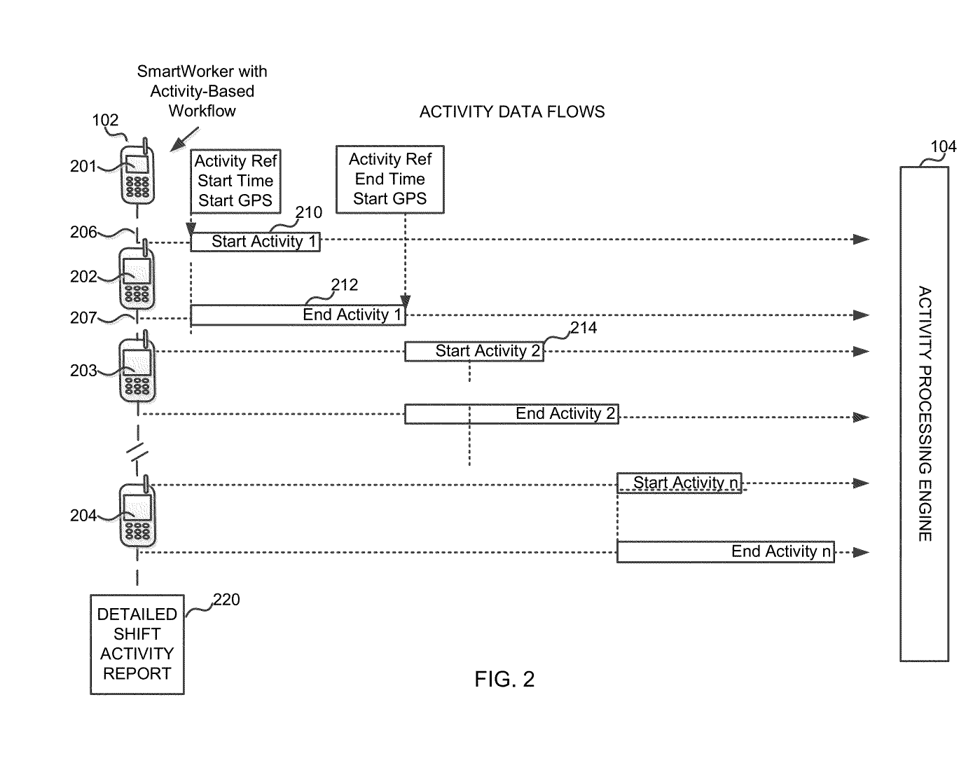

The component running on the mobile device 102 displays a workflow to the field-based worker which may be referred to as an ‘Activity-based Workflow’ and this is shown in the schematic diagram of FIG. 2 which shows the operation of the component running on the mobile device 102 and the communication of data from the mobile device 102 to the Activity Processing Engine 104.

As shown in FIG. 2, the component (which as described above, may be a hybrid-app running on the mobile device 102) displays an activity-based workflow. The term ‘workflow’ is used herein to refer to an ordered sequence of activities (or business processes) that guides the worker through their shift and which is implemented in software by the component. As shown in FIG. 2, the workflow is implemented in the form of a number of different screens 201-204 and one activity module may comprise one or more screens (some of which may be optional). The field-based worker causes the workflow to update (as indicated by the vertical dotted arrow in FIG. 2) by making user inputs to the component (e.g. by clicking on buttons within the component, which may be soft buttons rather than physical buttons) and the worker may be required to enter data into the component at various points in the workflow. At each transition point between activity modules within the activity-based workflow, the component triggers the transmission (e.g. push) of an activity transaction from the mobile device 102 to the Activity Processing Engine 104, as indicated by the horizontal arrows in FIG. 2.

Most transition points trigger two activity transactions, as shown in FIG. 2, with the exception of the first and last transition points of the shift/day. As shown in FIG. 2, at the start of the day, the first transition point (indicated by arrow 206) triggers a “start activity” transaction 210 which includes an activity reference, a start time and start location data (e.g. in the form of a GPS location of the mobile device). The “start activity” transaction 210 is transmitted to the Activity Processing Engine 104. In a “start activity” transaction, the end time and the end location data for the activity is unknown and so the fields in the transaction may be omitted or contain null data.

An example of a ‘start activity’ transaction is shown below:

<Activity>
<Ref>ACT-1223457</Ref>
<Ver>1</Ver>
<Ext/>
<ActivityDetail>

<ResourceRef>andy.potter</ResourceRef>
<TaskRef>DE_123456789</TaskRef>
<ParentActivityRef>ACT-1223456</ParentActivityRef>
<Basis>ACTUAL</Basis>
<Type>TRAVEL</Type>
<StartDT>2012-09-01T09:15:00+01:00</StartDT>
<StartGeotag>
<Lat>52.0244</Lat>
<Long>−1.0442</Long>
<Validity>CURRENT</Validity>
</StartGeotag>

</ActivityDetail>
</Activity>

In this example, the ParentActivityRef allows activities to be nested, thereby enabling complex hierarchical relationships to be represented. TaskRef is used to associate the activity (or group of activities) with a given task. Basis and Type allow for categorization and analysis of time and cost to different areas of interest. As described above, StartDT (date and time) and StartGeotag (GPS position) are not matched by corresponding ‘end’ items.

At the next transition point (indicated by arrow 207) two activity transactions 212, 214 are triggered. The first is an “end activity” transaction 212 which corresponds to the previous “start activity” transaction 210, but unlike the “start activity” transaction 210, the “end activity” transaction 212 includes the end time and the end location data as well as the activity reference. The “end activity” transaction 212 may include the previously transmitted start time and start location data or these fields in the transaction may be omitted.

An example of an ‘end activity’ transaction is shown below:

<Activity>
<Ref>ACT-1223457</Ref>
<Ver>2</Ver>
<Ext>
</Ext>
<ActivityDetail>

<Params>
<P name=“OdometerStart”>12345</P>
<P name=“OdometerFinish”>12365</P>
<P name=“LicencePlate”>AB12 XYZ</P>
</Params>
<ResourceRef>andy.potter</ResourceRef>
<TaskRef>DE_123456789</TaskRef>
<ParentActivityRef>ACT-1223456</ParentActivityRef>
<Basis>ACTUAL</Basis>
<Type>TRAVEL</Type>
<StartDT>2012-09-01T09:15:00+01:00</StartDT>
<FinishDT>2012-09-01T09:55:00+01:00</FinishDT>
<StartGeotag>
<Lat>52.0244</Lat>
<Long>−1.0442</Long>
<Validity>CURRENT</Validity>
</StartGeotag>
<FinishGeotag>
<Lat>51.9133</Lat>
<Long>−1.0215</Long>
<Validity>CURRENT</Validity>
</FinishGeotag>

</ActivityDetail>
</Activity>

The key difference between this example ‘end activity’ transaction and the example ‘start activity’ transaction included earlier is the addition of the FinishDT (date and time) and FinishGeotag entries, clearly identifying when and where the activity was finished. Params are parameters which are specific to an activity and contain data collected during that phase of work (e.g. data which may be input to one of the screens of the component running on the mobile device 102). In this example, these parameters include start and end odometer readings and a vehicle registration number (for an activity ‘travel’) which may be manually entered by the worker and/or accessed from standard settings entered into the component by the worker (e.g. the worker may enter their vehicle registration number only once per shift and this may be automatically added into the parameters for any subsequent ‘travel’ activity transaction).

The second activity transaction triggered at the second transition point is a “start activity” transaction 214 for the next activity. As before, the “start activity” transaction 214 includes an activity reference (for the next activity), a start time (which may be the same as the end time in the “end activity” transaction 212) and start location data (which may be the same as the end time in the “end activity” transaction 212). Both activity transactions 212, 214 are transmitted to the Activity Processing Engine 104.

This process of transmitting activity transactions at each transition point is repeated throughout the day, as shown in FIG. 2, to provide a picture of the activity of the field-based worker at every minute throughout the day. This picture may be referred to as a ‘Detailed Shift Activity Report’ 220 and this may be generated by the component running on the mobile device 102 and/or by the Activity Processing Engine 104. This picture of the activity of the worker may be complete (e.g. without any gaps in time and location) or there may be one or more gaps in time and/or location. Where there are gaps, a worker may be prompted (e.g. at the end of shift) to provide information to fill in the gaps (i.e. to explain them).

The activities which are tracked through the methods described above may include both task activities (e.g. travelling to the location where a task is to be performed, performing the task, collecting spare parts to enable the task to be completed, etc.) and non-task activities (e.g. lunch or coffee breaks, vehicle checks, refueling vehicles etc.). Each activity (whether task or non-task) may be coded (e.g. using an activity reference, as in the examples shown above) to allow central analysis by the Activity Processing Engine 104 and this analysis is described in more detail below.

Although it is not shown in FIG. 2, activities may be nested (e.g. such that a first activity starts, then a second activity starts before the first activity has finished) and this may be dependent on the scenarios in which the system is used as the activities undertaken will be dependent upon the environment in which the system is used. As shown in the examples above, a ParentActivityRef may be used to track the nesting of activities within start and end activity transactions.

Referring back to FIG. 1, the Activity Processing Engine 104 receives activity transactions from a plurality of mobile devices 102 (arrow 110 and as shown in FIG. 2). FIG. 1 also shows a number of operations 1-4 which are performed by the Activity Processing Engine 104. It will be appreciated that the Activity Processing Engine 104 may perform some or all of these operations and/or may perform additional operations.

As activities are received from the field they are checked for the correct sequencing and various calculations are performed to enrich the data, such as calculating the duration of each activity (operation 1). Activities may be passed through to a component or module (within the Activity Processing Engine 104) which (in operation 2) generates the appropriate service delivery milestones (e.g. arrived, broken appointment, closed fixed, etc.) and calculates service effectiveness KPIs (Key Performance Indicators). The service delivery milestones may, for example, be derived based on data entered into the component running on the mobile device 102 (e.g. and communicated to the Activity Processing Engine 104 as Params in the examples above) and/or by options taken within the activity-based workflow. For example, the possible exits from a transition activity (the activity which starts when the worker arrives at the correct location) may be ‘person not at home’ or ‘started assessment of appliance’. Selection of ‘person not at home’ may be interpreted, when generating the service delivery milestones, as closing the task.

Outputs from operations 1 and 2 are fed into a behavioral analysis module (within the Activity Processing Engine 104) which looks for ‘interesting things’ which are judged by the employer to be of value in their operation (operation 3). These ‘interesting things’ which are pre-defined within the system may be referred to as ‘anomalous events’ and examples of these include (but are not limited to): gaps in location and/or time (e.g. where a worker started a shift and then did not leave for their first task for 30 minutes), variations from plan, variance in reported vs. actual timing; oddities in relationships between activities, activities and tasks or activities and parameters associated with the activity e.g. activity not taking place at the right location.

All the information (including the anomalous events generated in operation 3) is fed through to a normalization and scoring module which allows the data to be aggregated up to a single score for each worker's shift (operation 4) and which may be presented in the GUI 108, e.g. form of a field-worker scorecard. As is described in more detail below, although the normalization and scoring module may generate (in operation 4) a single score for each field-worker's shift, in some examples a single score may not be generated and instead a plurality of scores may be generated (without a single aggregate score). Where a single score is generated, this may be presented alongside more detailed information in the GUI 108.

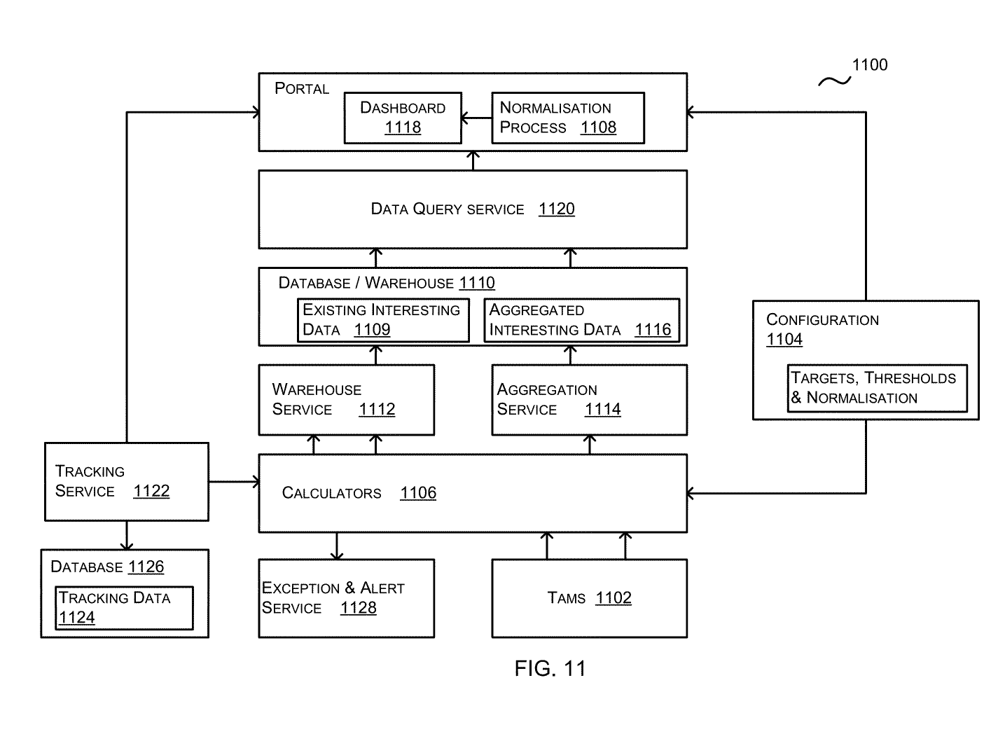

As described above, the Activity Processing Engine 104 may comprise a number of modules arranged to perform the operations described above. It will be appreciated that these modules may be co-located (e.g. they may all run on a single server) or the Activity Processing Engine 104 may itself be distributed with different modules running on different servers which may be geographically co-located or distributed. Example implementations of the Activity Processing Engine 104 are described below with reference to FIGS. 11-14.

It will further be appreciated that although the system is described as a whole, different parts of the system may be implemented and operated separately, such that a first entity implements and operates the component running on the mobile device 102, a second entity implements and operates the Activity Processing Engine 104, a third entity implements and operates the presentation of the information in the GUI 106 and a fourth entity maintains the data store 108. Alternatively, any entity may implement and/or operate any subset of the system.

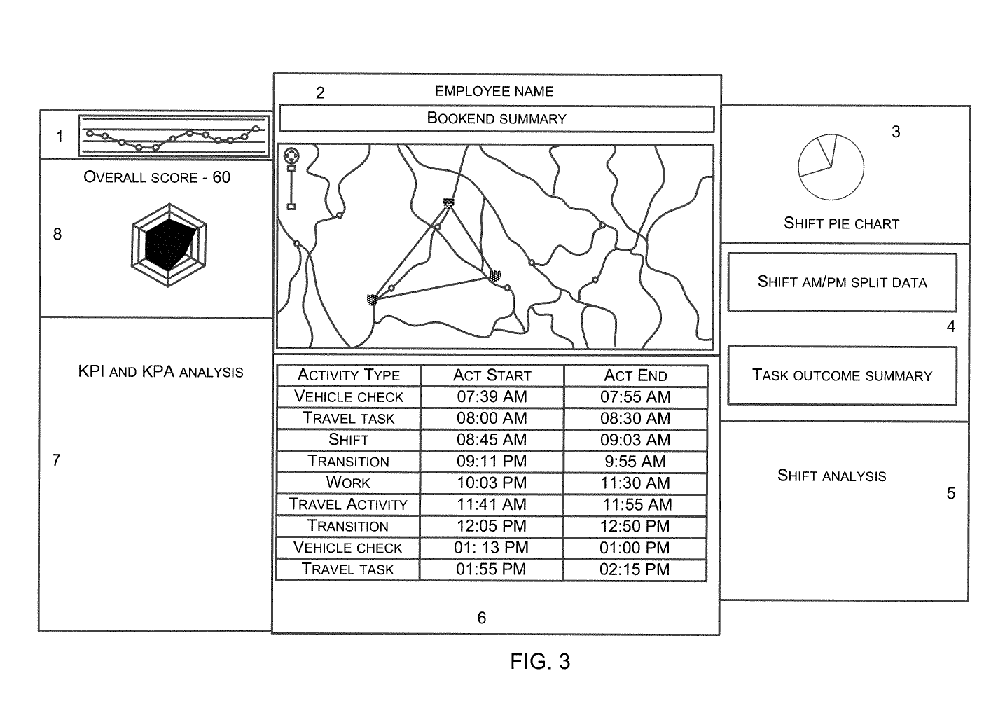

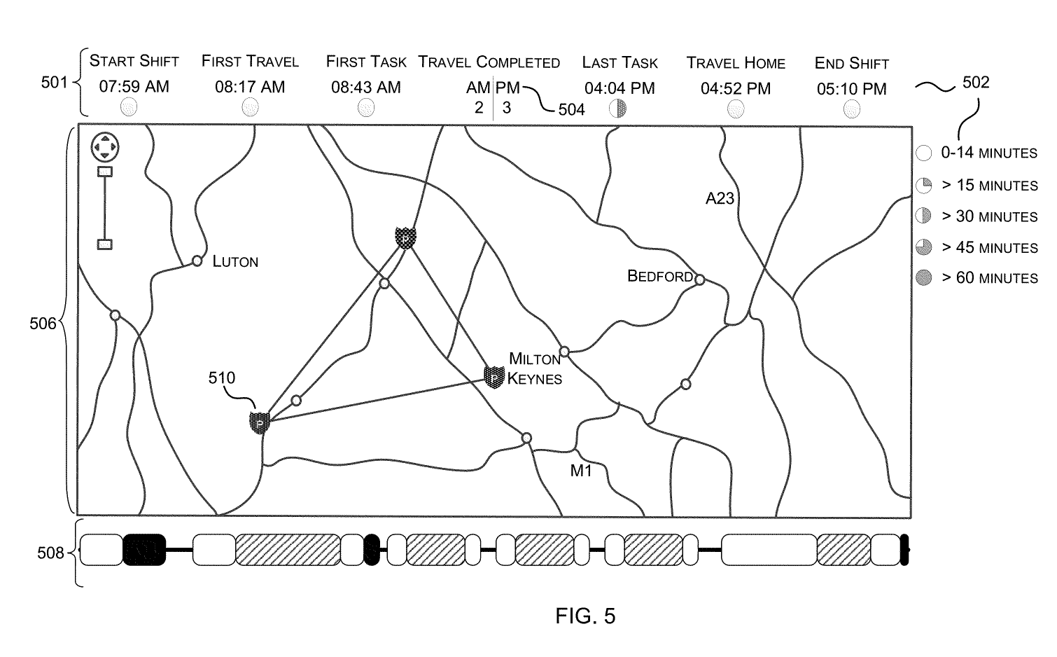

FIG. 3 shows an example of a field-worker's score card which may be presented in the GUI 108 and parts of the score card are shown in more detail in FIGS. 5-9. This score card, which is displayed within the GUI as a single screen, provides objective data about how the worker performs and may be presented to a manager of the field-worker and/or the field-worker themselves and it will be appreciated that the system may be configured to present different information (e.g. different subsets of the available information) to different people depending upon their role or level of authorization. This score card provides detailed information on one shift (or day) of the field-based worker and in addition the score card provides statistics which are based on the current shift (to which the score card relates) and previous shifts. By presenting all the information in a single screen, the field-worker's score card provides a balanced approach and enables the reviewer to see (and value) more than one behavior (e.g. more than just the completion of tasks, which is all that is monitored in known task-based approaches).

In the example score card 300 shown in FIG. 3, section 1 comprises a Control Chart which plots the Overall Score (as shown for the particular shift in section 8) over time (e.g. in the form of a graph) to show how the worker's performance is trending. This information is useful because a single score in isolation does not help identify patterns of worker behavior, this graph highlights repeat behaviors so that they can be identified and rewarded (if appropriate) or ultimately corrected. The single score is representative of the field-worker's behaviors and not just the outcomes of the tasks which the worker has undertaken.

Section 2 (which is shown in a more detailed example in FIG. 5) comprises a Bookend Shift Summary 501 which communicates in a graphical manner any waste at the start and end of the day and the AM/PM task completion split 504. The ‘Start Shift’ and ‘End Shift’ times (within the Bookend Shift Summary 501) may be considered to be ‘bookends’ which define a period in which the system is authorized to monitor the activities of the field-based worker and the worker will have input these start and end times to the mobile component in some way (e.g. by entering a time or by clicking on a start/end shift button). Within the Bookend Shift Summary 501, a clock symbol 502 is used to quickly identify unexpected long durations during the start and end of the working day. Experience of typical Field Worker behaviors shows that there is a lot of time wasted in the morning and late afternoon, this graphic is designed to quickly highlight any extensive durations around this period of the day. In the example shown the clock symbol 502 is progressively colored in with each quarter which is colored black indicating a period of 15 minutes over tolerance. For example, a field-based worker may be required to start their shift between 6.30 am and 9.30 am and if the shift starts within this period (as in the example shown in FIG. 5) or less than 15 minutes outside this period, the clock is empty (e.g. a black outline of a circle). If the shift does not start until 9.45, however, the clock will be one quarter black to indicate that the start shift time was 15 minutes late. The clock would also be one quarter black if the shift started at 6.15 am (i.e. 15 minutes early). If the shift does not start until 10 am, the clock will be half black to indicate that the start shift time was 30 minutes late, etc. Similarly, if a field-based worker is required to end their shift between 4.30 pm and 6.30 pm, the clock indicates whether, and by how much, a shift ended outside this period (e.g. before 4.30 pm or after 6.30 pm).

The Bookend Shift Summary 501 shown in FIG. 5 also tracks the time that the field-based worker starts their first travel segment (i.e. travelling from home to the first job of the day), the time that the field-based worker starts their first job, the time that the field-based worker starts their last job of the day and the time that the field-based worker starts their travel home (from the last job of the day). The tolerances which are displayed by these clocks may be defined relative in absolute terms (as with the start and end shift examples above) or they may be defined relative to the actual start or end shift time. For example, if the travel home starts more than one hour before the end shift time, this may be indicated by the ‘travel home’ clock and if the first travel starts more than 15 minutes after the start shift time, this may be indicated by the ‘first travel’ clock. In other examples, the tolerances may be dynamically calculated based on details of the jobs completed by the field-based worker. For example, if the field-based worker starts his first travel at time T1 (at his home location) and the journey to the location of the first job is expected to take time T2, the tolerances indicated by the ‘first task’ clock may be defined relative to time T1+T2 or time T1+T2+dT where dT is an extra time margin added to account for possible traffic congestion.

The Bookend Shift Summary 501 in FIG. 5 also shows the split of tasks between the morning and afternoon 504. It will be appreciated that uneven split data on its own does not necessarily indicate a problem and the split is instead viewed with reference to the start and end shift times. For example, if a field-based worker starts their shift later in the morning and works later into the evening, the task split is likely to be uneven with fewer tasks being performed in the morning simply because the worker's shift was not evenly split across midday.

The tolerances (i.e. the expected times or durations) for each of the clocks in the Bookend Shift Summary 501 may be defined in one or more rule sets which may be applied to the data received in the activity transactions from the mobile device.

Section 2 also comprises a map 506 and a Gantt chart 508 which represent the shift to which the score card 300 relates. The map 506 shows the locations of the field-based worker at the time of activity transactions and the locations may be marked with icons 510 which show additional information such as activity types, tolerance information, etc. As such the map may be described as having overlaid task and activity data for the particular shift. The blocks on the Gantt chart indicate visually the different activities and highlight missing periods of data and abnormal gaps between activities.

Section 3 comprises a Pie Chart which graphically displays productivity and utilization based on Actual shift and Paid shift durations. This chart quickly communicates a high-level summary of how the time recorded by the Worker for the day was spent (productivity). For employers with an expected shift duration (e.g. a fixed definition or more dynamic definitions), this may be extended to include assessment of utilization. In the example shown in FIG. 3 there are three categories (productive time, productive travel and non-productive time); however specific emphasis may be placed on understanding the non-productive time which, if reduced, has the potential to be utilized for increased productive/revenue-generating activities.

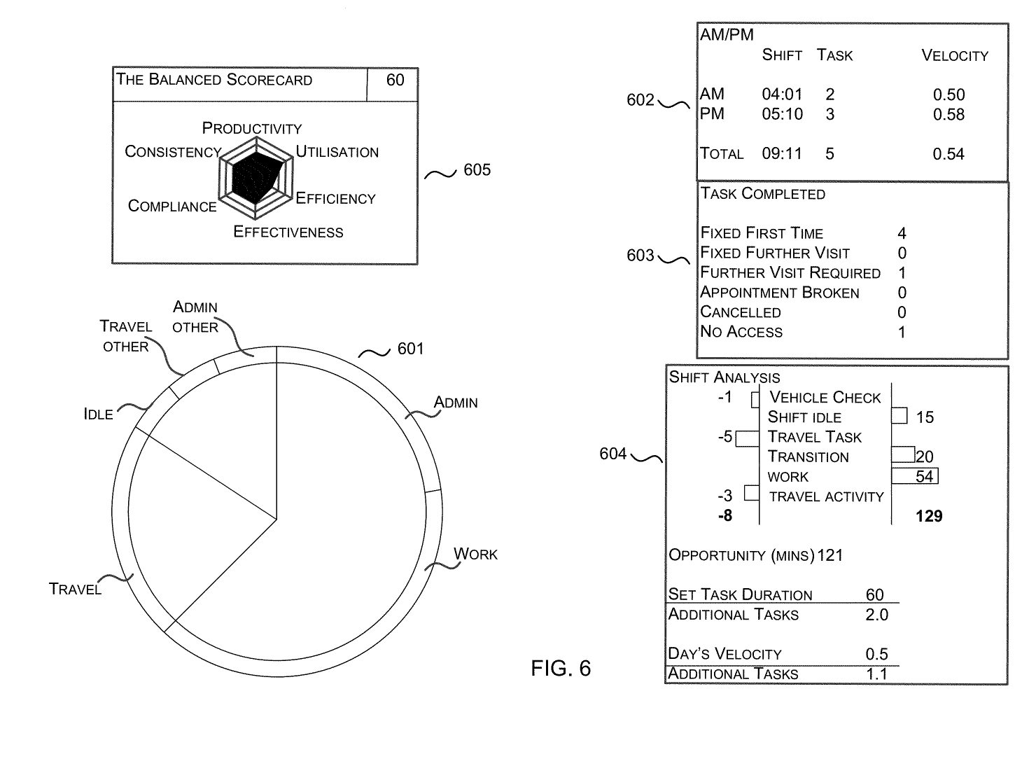

A further example 601 of section 3 of the score card is shown in FIG. 6. In this example, additional information is provided within the pie chart to provide, at a glance, a breakdown of the activities within the productive time (e.g. admin and work) and the non-productive time (e.g. admin other, travel other and idle). No breakdown is required of the productive travel segment as this represents a single activity. This breakdown of the non-productive time is useful as not all non-productive time is time wasted. For example, the ‘admin other’ category may include the start of day vehicle checks which are essential and the ‘travel other’ category may include the travel home from the last job of the day which cannot be eliminated entirely, but may be reduced by scheduling the last job to be the one closest to the field-worker's home location.

Section 4 (which is shown in more detail in FIG. 6) comprises high level shift summaries: the AM/PM Summary 602 and the Task Outcome Summary 603. The shift duration and tasks completed are used to calculate velocity (i.e. the number of completed tasks per shift hour) which is a nice summary of efficiency and this is shown over an AM/PM split in the AM/PM Summary 602. This highlights particular behaviors, such as a field-worker rushing their morning (AM) tasks, only to significantly reduce their level of effort in the afternoon (PM). This behavior has an impact on efficiency and effectiveness within the operation, and can be ‘the traditional curse’ to known Dynamic Scheduling implementations. A Dynamic Resource Scheduler (DRS) is a complex piece of software that matches work to be done to the best worker in real-time. In order for this to work, each job (task) is provided to the DRS with a predicted duration. Workers either consistently not achieving these ‘planned’ durations or varying their performance (speeding up in the morning and slowing in the afternoon) removes the ability of the DRS to plan the schedule effectively. The Task Outcome Summary 603 comprises data displaying both effectiveness and a breakdown of undesirable task outcomes, to guide continuous improvement activities (e.g. assessment of stock profiles, training needs, etc.). These high level shift summaries shown in section 4 may be aggregated over time, instead of, or in addition to, showing the results for the particular shift to which the score card 300 relates.

Section 5 (which is shown in more detail in FIG. 6) comprises Shift Analysis data 604. Time that occurs outside of the expected duration is totaled and shown next to the activity type to show where a worker has been under/over planned time. This is designed to both highlight unexpected activity durations, and to introduce an indication of the potential impact of waste (“lost opportunity in minutes”). The reasons for this apparent waste may be due to; the scheduler, incorrect activity capture, or a genuine over-run on a given activity—understanding all of these assists towards improving the performance of an individual. It can be seen in section 5 that the opportunity which is identified (i.e. the potentially wasted time that could have been used for productive activity) is recorded both in terms of time (e.g. 121 minutes) and in terms of additional tasks that could possibly have been performed by the field-based worker. The number of additional tasks may be calculated in two different ways—based on the average length of time of a task or job (e.g. 2 additional jobs) or based on the task velocity for that shift (e.g. 1.1 additional jobs)—and these may give slightly different answers.

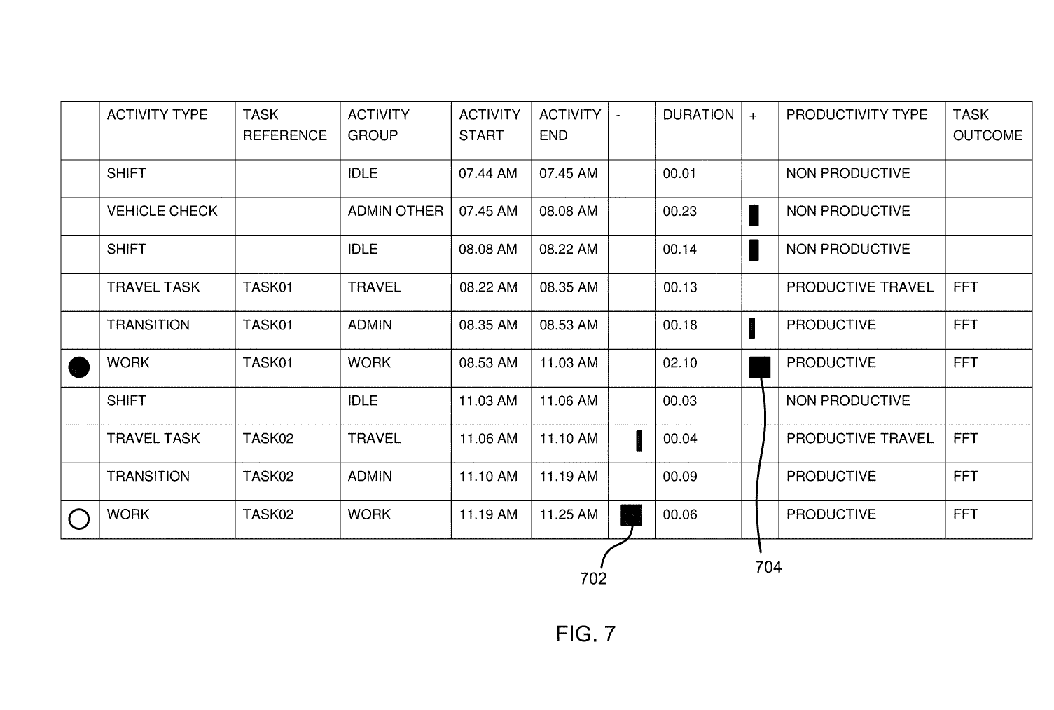

Section 6 is the timecard which shows the detailed report of what was done during the shift. A further example of a section 6 is shown in FIG. 7 in more detail. Both activity times that occur outside of expected/planned duration, and activities with undesirable outcomes are highlighted as ‘exceptions’ on the timecard (e.g. using different colored bars 702, 704). Promoting the principle of ‘Management by Exception’, this element of the scorecard is designed to draw the attention of the user to any specific areas of the timesheet that are most likely to be of interest (i.e. it is unexpected therefore we need to understand “why?” it occurred, in order to define operational improvement steps).

Although the section 6 shown in FIG. 3 may only show a few columns of data for reasons of clarity, as shown in FIG. 7, section 6 may comprise the following columns of data:
Activity type: this is the actual activity that is being performed. Where no activity type is specified, the highest level activity type (e.g. ‘Shift’) may be used.
Task reference: this is blank for activities which are not directly related to a task and so from viewing FIG. 7 it is apparent how much non-task related data is captured by the systems and methods described herein.
Activity group: this is a categorization for the specified activity type (e.g. travel is part of the travel task group, transition is part of the admin group, etc.). In various examples, the activities may be arranged in a tree structure with ‘shift’ at the highest level, the activity groups at the next level down and the activity types on the level underneath the activity groups.
Activity start time
Activity end time
Activity duration
Productivity type: this example uses types productive, non-productive and productive travel and this then is reflected in the pie chart in section 3 (described above).
Task outcome: in the example in FIG. 7 the only outcome shown is ‘fixed first time’. Other outcomes may include ‘further visit required’ (e.g. when the equipment was not fixed), ‘fixed further visit’ (e.g. when the equipment was fixed but this was not the first visit), ‘no access’ (e.g. when the worker was unable to gain access to the property and/or equipment), etc.

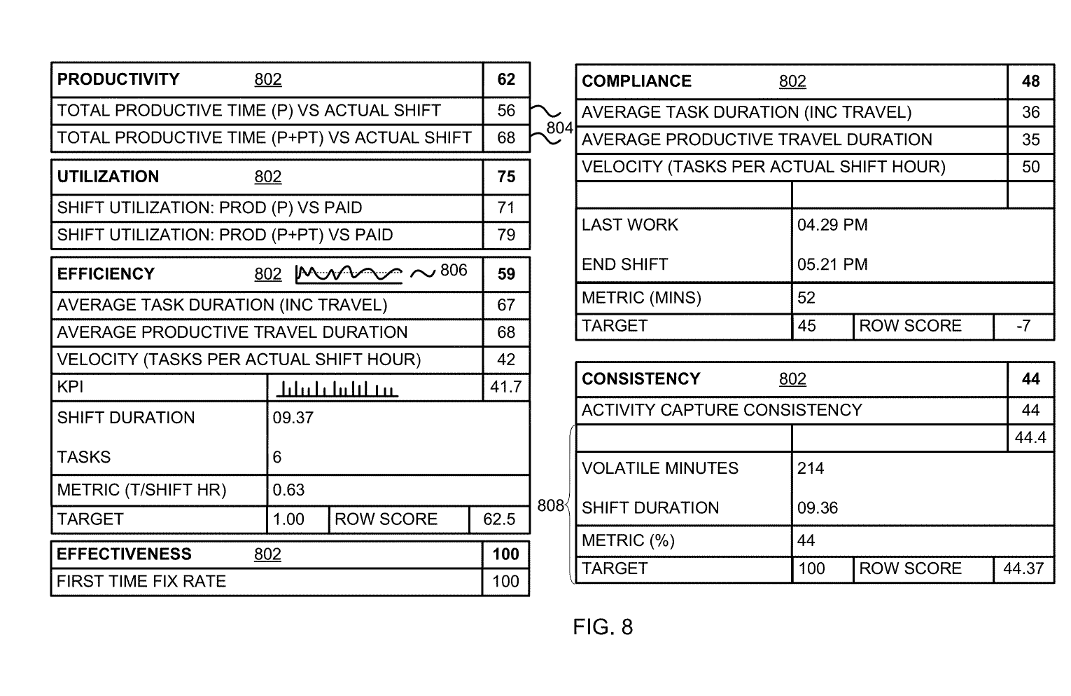

Section 7 (which is shown in more detail in FIG. 8) shows the Key Performance Indicators (KPIs) which are the building blocks of Performance Management, and what may be seen as the most effective method of analyzing a workforce, when KPIs across different perspectives of performance, are displayed simultaneously, in effective combination. Ultimately this KPI information is an enabler, it allows a business to aggregate and compare performance across different dimensions—both the organizational structure and time in the first instance—to better understand a business. It is only by reviewing these performance perspectives in combination, that a business can identify effective improvement strategies. Established from a configurable mix of underlying metrics, and with the ability to apply configurable weightings to the contribution of these metrics, the KPIs themselves are calculated/presented in a ‘normalized scale’ (0-100), to allow simplified evaluation by the User. The configuration allows the KPIs to better reflect the specific strategies and policies of the individual Customer operation, and to enable a meaningful single ‘day score’ (as shown in section 8 of the score card) to be calculated/presented. By simplifying a complex combination of metrics, across multiple different performance perspectives, the provision of a single ‘day score’ represents an opportunity to enable much improved communication and comparison of performance throughout the operation (and most importantly to the Field Workers themselves). Once normalized, this single score may be used in many different ways (e.g. to generate league tables, influence scheduling rules, etc.).

Although a business may have 50-60 KPIs, the score card 300 shows only a small number (e.g. 10-15 KPIs) grouped into Key Performance Areas (KPAs). The example of section 7 of a score card shown in FIG. 8 comprises six KPAs 802 and under each KPA 802 there are one or more KPIs 804. Each KPI has its own normalized score and each KPA has a normalized score which is a weighted sum of the normalized scores of the KPIs within the KPA. The single score of the entire shift (which is shown in section 8) is then a weighted sum of the KPA scores. The weighted sum that is used to calculate a KPA score from normalized KPI scores may be fixed or may be variable. In various examples, the weighted sum may change (e.g. the weights associated with each KPA may change) dynamically. For example, the weighted sum used may be different at different times of the year to reflect the different work types at those different times (e.g. emergency call outs in winter months and preventative maintenance and service visits at other times of year) and the different behaviors which are required for the different work types. In an example, the six KPAs which are used may be: productivity, utilization, efficiency, effectiveness, compliance and consistency, although this may change. Similarly, the weighted sum of normalized KPIs which is used to calculate a KPA score may be fixed or variable (and may vary dynamically) and the KPIs which are used to calculate a KPA score may also be fixed or variable.

The productivity KPA may be formed from two KPIs: the percentage of the actual shift duration which was productive work (‘Total Productive Time (P) vs Actual Shift’) and the percentage of the actual shift duration which was either productive work or productive travel (‘Total Productive Time (P+PT) vs Actual Shift’).

The utilization KPA may also be formed from two KPIs where again the first does not include the productive travel time (‘Prod (P) vs Paid’) and the second does (‘Total Prod (P+PT) vs Paid’), where ‘Paid’ is the contracted hours of the field-worker.

The efficiency KPA may be formed from three KPIs: the average actual task duration including travel time to the job, the average actual travel time to the job and the velocity. The velocity, as described above with reference to section 4 of the score card 300, is the number of completed tasks per shift hour.

The effectiveness KPA may be formed a single KPI, the percentage of completed tasks which were fixed on the first time visit (‘First time fix rate’).

The compliance KPA may be formed from four KPIs: the duration from the shift start to the start of the first productive travel (‘Time to First Travel from Start Shift’), the duration from the shift start to the start of the first productive work (‘Time to First Task from Start Shift’), the duration from the last task completion to the shift end (‘Time from Last Task to End Shift’) and the duration from the last start travel (productive travel or travel home) to the shift end (‘Time from Last Travel to End Shift’). The compliance KPA may also include a fifth KPI which is a comparison of the length of the shift compared to the paid time of the shift (‘Shift Duration (Paid v Actual)’).

The consistency KPA may be formed from a single KPI, the total of the variance from expected activity duration (‘Activity Capture Consistency’). This is calculated based on stored ranges of expected duration, with each activity type having an associated stored range (e.g. an activity type ‘vehicle check’ may be expected to take 3-7 minutes). This KPI measures the duration that falls outside the expected range and a record is returned for each activity type within each shift and for each instance of each activity type (e.g. where an activity type occurs more than once within a shift).

As shown in FIG. 8, the score card may also show a graph 806 of historic performance for each KPA (in a similar manner to the historic performance for the overall score which is shown in section 1 of the score card 300. Additional detail 808 may also be shown for some of the KPIs.

Section 8 (which is shown in more detail in FIG. 6) is the Balanced Scorecard Radar Chart 605 which graphically represents the normalized KPA scores and derives a balanced assessment of overall performance. Section 8 also shows the single score for the field-based worker's shift, which in this example is 60. This single score for the shift is based on a best practice definition of the skills that the field-worker should have and may be specified for a particular company that the field-worker works for or at a lower level of granularity (e.g. based on the field-worker's role within the company, with different roles requiring a different balance of the selected six KPAs and/or different KPIs within a KPA).

The data which is presented within the score card 300 may be updated in near real-time, i.e. with only a short delay for the data to be received from the mobile devices, and this enables a scheduler or management to react and influence activity within a shift. In various examples, however, data may be compiled for completed shifts and this data may be analyzed and reacted upon by an automated system (such as a scheduler) or by a human (e.g. the field-worker's manager).

Sections 8, 2 & 3 of the score card 300 shown in FIGS. 3, 5 and 6, when used in combination can communicate a very quick summary; was the shift was good/bad and if more information is required the rest of the page holds the detail; it answers the “What happened?” and “Was it good/bad?” and provides the information to ask the “Why?”, i.e. the supporting information is detailed enough to allow management to have discussions with workers around their behavior so that it can be corrected (all of which will drive continual improvement).

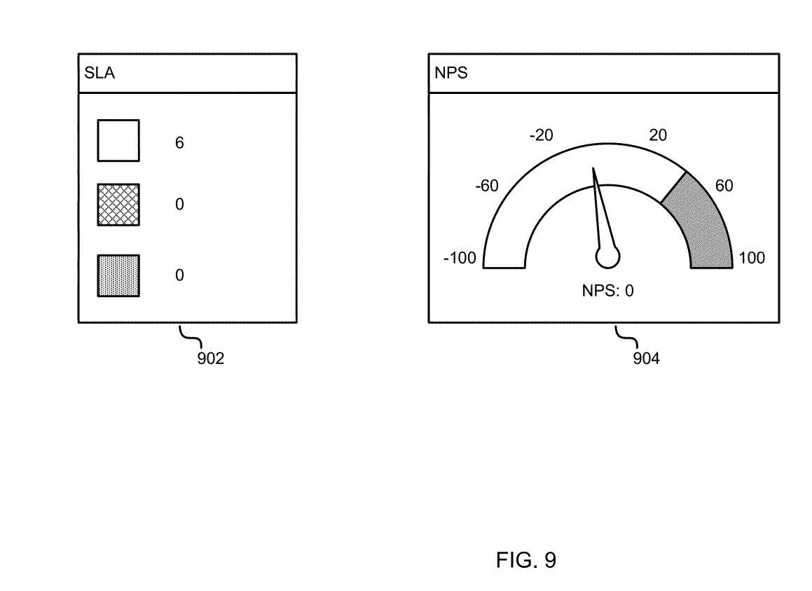

It will be appreciated that the score card 300 shown in FIG. 3 may comprise additional elements. In various examples, a field-worker's score card may additionally comprise service level agreement (SLA) metrics (e.g. whether the tasks completed by the worker in the shift satisfied the SLAs with the customers) and/or customer feedback data. These two elements are shown in FIG. 9 and in the example shown, the SLA element 902 indicates that all 6 jobs completed by the worker in the shift represented by the score card met their relevant SLA (i.e. each job satisfied the SLA which covers that particular job, where different jobs may be covered by the same SLA or different SLAs). The three categories within the SLA element 902 may, for example, indicate passes (where the SLA milestone occurred inside the start and end SLA date/times), fails (where the SLA milestone occurred outside the start and end SLA date/times) and misses (where the SLA milestone did not occur for the task, e.g. due to a broken or cancelled appointment). In the example shown in FIG. 9, the customer feedback is represented as a Net Promoter Score (NPS) score 904 and in various examples, the customer may input data during the job directly into the component running on the mobile device. For example, there may be a customer feedback screen or module within the component and the customer may click buttons and/or enter text to provide feedback. Alternatively, feedback may be collected via a separate channel after the job has been completed (e.g. by post, email or phone).

A score card such as the one shown in FIGS. 3 and 5-9 provides a tool for management of workers based on objective information collected at a very low (i.e. fine) level of granularity. It enables identification of workers who are performing well and identification of workers who may require additional training/guidance. Comparison of multiple score cards for different workers may also enable identification of process improvements (e.g. where all workers have their efficiency impaired by a particular activity or aspect of an activity).

By use of systems as described above and a score card (such as the one shown in FIG. 3) which is generated by the Activity Processing Engine, it is possible to answer the following questions:

A) What is happening ( . . . at the front lines of my business)?

### B) Was it Good/Bad?

C) What are the opportunities for improvement, and which are the imperatives?
D) What action should we take, to improve (whilst avoiding potential unintended consequences)?
E) Did our actions have an impact?
F) Were the impacts all positive/expected/etc.?

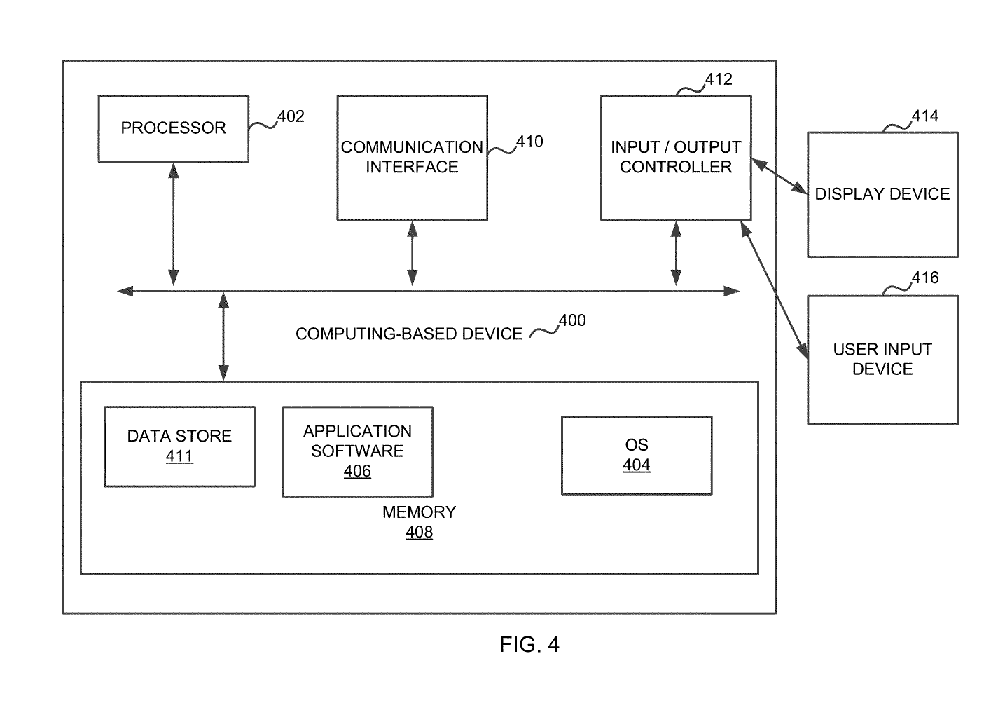

FIG. 4 illustrates various components of an exemplary computing-based device 400 which may be implemented as any form of a computing and/or electronic device, and in which embodiments of the methods described above may be implemented. In particular, the computing-based device 400 may operate as the mobile device 102, the server running the Activity Processing Engine 104 and/or the computing-based device displaying the GUI 108.

Computing-based device 400 comprises one or more processors 402 which may be microprocessors, controllers or any other suitable type of processors for processing computer executable instructions to control the operation of the device in order to implement any of the methods described herein. In some examples, for example where a system on a chip architecture is used, the processors 402 may include one or more fixed function blocks (also referred to as accelerators) which implement a part of the method of data analysis in hardware (rather than software or firmware). Platform software comprising an operating system 404 or any other suitable platform software may be provided at the computing-based device to enable application software 406 to be executed on the device. Depending on whether the computing-based device 400 is the mobile device 102, the server running the Activity Processing Engine 104 and/or the computing-based device displaying the GUI 108, the application software 406 may comprise one or more of: the component running on the mobile device (e.g. as described above with reference to FIG. 2), the Activity Processing Engine 104 or modules which form part of the Activity Processing Engine 104 (such as an a sequencing module, a milestone generation module, an analysis module and a normalization and scoring module, which implement operations 1-4 shown in FIG. 1 respectively and are described above).

The computer executable instructions may be provided using any computer-readable media that is accessible by computing based device 400. Computer-readable media may include, for example, computer storage media such as memory 408 and communications media. Computer storage media, such as memory 408, includes volatile and non-volatile, removable and non-removable media implemented in any method or technology for storage of information such as computer readable instructions, data structures, program modules or other data. Computer storage media includes, but is not limited to, RAM, ROM, EPROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer readable instructions, data structures, program modules, or other data in a modulated data signal, such as a carrier wave, or other transport mechanism. As defined herein, computer storage media does not include communication media. Although the computer storage media (memory 408) is shown within the computing-based device 400 it will be appreciated that the storage may be distributed or located remotely and accessed via a network or other communication link (e.g. using communication interface 410).

The memory 408 may also comprise a data store 411. This data store 411 may operate as data store 106 and/or may be used to store any other data generated by or received by the computing-based device 400.

The communication interface 410 may be used to transmit or receive data (e.g. to send or receive activity transaction data).

The computing-based device 400 may also comprises an input/output controller 412 arranged to output display information to a display device 414 which may be separate from or integral to the computing-based device 400. The display information may provide a graphical user interface (e.g. the GUI 108 or the GUI of the component running on the mobile device 102). The input/output controller 412 is also arranged to receive and process input from one or more devices, such as a user input device 416 (e.g. a mouse or a keyboard). Where the computing-based device 400 is the mobile device 102, the user input may be used to interact with the activity based workflow GUI displayed on the display 414. In an embodiment the display device 414 may also act as the user input device 416 if it is a touch sensitive display device. The input/output controller 412 may also output data to devices other than the display device, e.g. a locally connected printing device (not shown in FIG. 4).

As described above, the component running on the mobile device 102 may be an application. This gives access to functionality within the mobile device and/or the operating system of the mobile device which would not be available if the component was a web page running within a web browser application on the mobile device. FIG. 10 is a schematic diagram showing various components of an exemplary mobile device 1000 in which embodiments of the methods described above may be implemented. It can be seen that many of the components of the mobile device 1000 are as shown in FIG. 4 and described above, such as a processor 402, operating system 404, application software 406, memory 408, data store 411, input/output controller 412, display device 414 and user-input device 416. It can be seen that the display device 414 and user-input device 416 are integrated within the mobile device 1000 and as described above, the display device 414 may be a touch-sensitive display and act as both the display device and a user-input device 416 (although there may also be physical buttons which act as further user-input devices 416). The mobile device 1000 further comprises a GPS module 1002 and a wireless module 1004. The wireless module 1004 comprises a wireless transmitter and receiver and enables the mobile device 1000 to communicate with other devices (e.g. with a server running the Activity Processing Engine 104 and with other mobile devices).

FIG. 10 also shows the mobile component in the form of a hybrid mobile application 1008 referred to as the ‘SmartWorker’ application. This application operates when online (e.g. when the mobile device is connected to the server running the Activity Processing Engine 104) and also when offline (e.g. when there is no connectivity to the server running the Activity Processing Engine 104). As shown in FIG. 10, the application may comprise an application clock 1010 which is independent of the system clock which is maintained by the operating system 404 and visible to the user. The application clock 1010 is a tamper-proof clock which is synchronized with the Activity Processing Engine 104 at least periodically (e.g. it may synchronize whenever there is connectivity to the Activity Processing Engine 104). The SmartWorker application 1008 may display the time according to the system clock; however, all activity transactions (e.g. activity transactions 210-214 shown in FIG. 2) are referenced to the application clock 1010 (i.e. parameters StartDT and FinishDT in the example transactions above reference the application clock 1010). In the event that the user changes the time of the system clock, this may be recorded by the SmartWorker application 1008; however, this does not affect the time stamps included within an activity transaction.

FIG. 11 is a schematic diagram of an example Activity Processing Engine 1100 (e.g. as shown in the system in FIG. 1). The Activity Processing Engine 1100 receives data in via a TAMS (Task Activity Milestones Services) adapter 1102 from both the mobile component (e.g. on mobile device 102 in FIG. 1) and an organization's enterprise resource planning (ERP) software, such as software provided by Oracle™ or SAP™. The TAMS adapter 1102, provides a standard interface between the Activity Processing Engine 1100 and both the mobile component and the ERP software. The TAMS adapter 1102 puts data onto a bus within the Activity Processing Engine 1100 in the correct format to be picked up (i.e. input to) other modules within the Activity Processing Engine 1100.

Parameters which are used by the Activity Processing Engine 1100, such as rule sets and thresholds, are stored in a configuration module 1104. This enables the parameters to be varied and in various examples, different parameters (e.g. rule sets and thresholds) may be stored for different types of field-worker. These parameters may, for example, include the weights used in generating KPAs and the overall shift score, activity duration thresholds (i.e. the expected time or range of time for an activity), the expected time between certain milestones (e.g. first travel, last work, etc.), the paid time for a worker (e.g. their contracted shift length). The configuration module 1104 feeds the parameters into one or more calculators 1106 and a normalization module 1108.

The calculators 1106 receive data which is added to the bus by the TAMS adapter 1102 and parameters from the configuration module 1104 and generate values, such as an activity duration, based on the received data and parameters. These values 1109 (which are denoted ‘Existing Interesting Data’ in FIG. 11) are then stored in a database (or warehouse) 1110 by a warehouse service 1112. The warehouse service 1112 provides a clean and safe interface to the database. Some values which are calculated by the calculators 1106 are input to an aggregation service 1114 which uses the values received to calculate the metrics used by the system. These metrics 1116 (which are denoted ‘Aggregated Interesting Data’ in FIG. 11) are then stored in the database 1110 by the aggregation service 1114. The aggregation service 1114 may continually process data received and/or it may be triggered at the end of each shift. Where the aggregation service 1114 is triggered at shift end, it may extract data from the database 1110, generate the metrics 1116, and then store the metrics in the database 1110, rather than receiving the data directly from the calculators 1106.

The data which is displayed within the GUI (or dashboard) 1118 is accessed from the database 1110 using data queries performed by a data query service 1120. Although FIG. 11 shows that the normalization process is performed on the fly by a normalization module 1108 which is separate from the aggregation service 1114 and acts on data received using data queries, in other examples, the normalization module 1108 may form part of the aggregation service 1114 with the normalized values being stored in the database 1110 and then extracted by the data query service 1120 when required for inclusion within the GUI 1118.

As described above, the data which is received from the mobile component may be geotagged to show the location of the field-worker at the time an activity transaction is generated. This geotagged data is received via the TAMS adapter 1102. In various examples, the field-based worker's mobile device may be tracked separately via a tracking service 1122. This tracking service 1122 provides location information for the field-based worker separate from any activity transactions which are generated and so provides location information for the worker between activity transaction points. The tracking data 1124 may be stored in a database 1126 which may be separate from, or integrated with, database 1110.

In various examples, the Activity Processing Engine 1100 may further comprise an exception and alert service 1128 which provides notifications (e.g. to a manager of a field-worker) when particular exceptions occur. These notifications may be configured dependent upon an organization's requirements and provide real-time notifications of problems which may be useful if the perspective views described above are not constantly monitored.

Referring back to FIG. 1, the calculators 1106 in FIG. 11 may form the “Milestone generation and service KPI calculation” module in FIG. 1 and the aggregation service 1114 may form the “Behavioral analysis” module in FIG. 1.

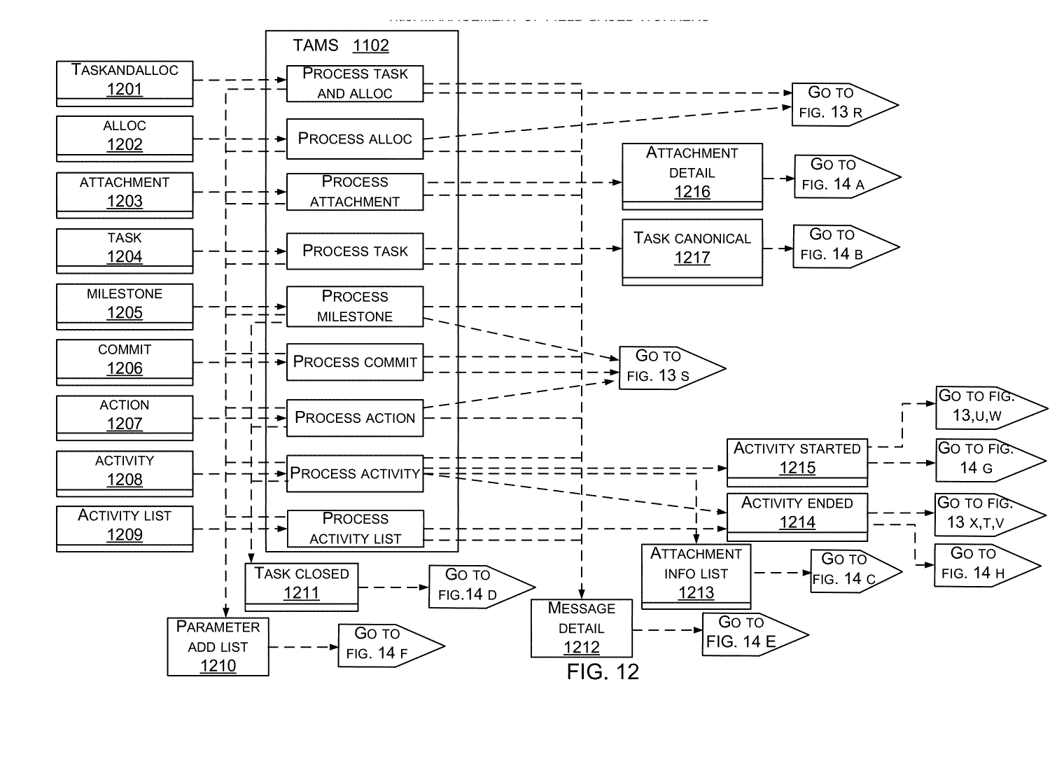

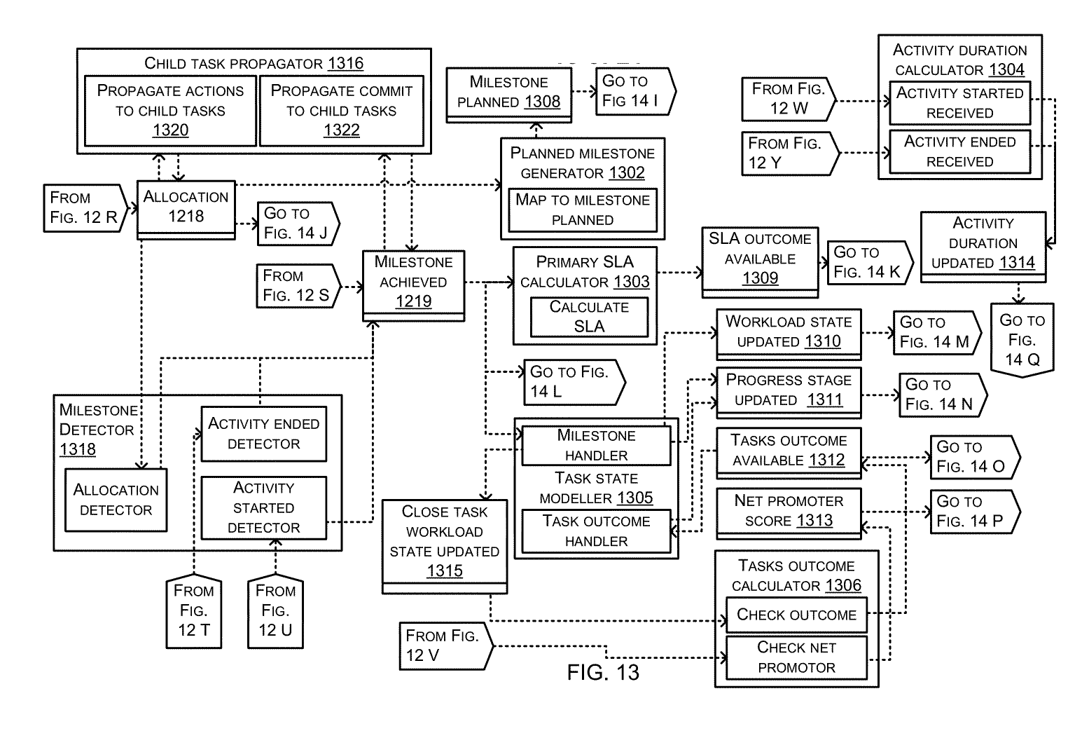

FIGS. 12-14 are schematic diagrams of a further example Activity Processing Engine (e.g. as shown in the system in FIG. 1). FIG. 12 shows another example of a TAMS adapter 1102 (as described above). As shown in FIG. 12, the TAMS adapter 1102 receives a number of data items 1201-1209 from the mobile component and the ERP software, converts them to the right format (where required) and outputs a number of data items 1210-1219 onto a bus within the Activity Processing Engine (items 1218-1219 are shown in FIG. 13).

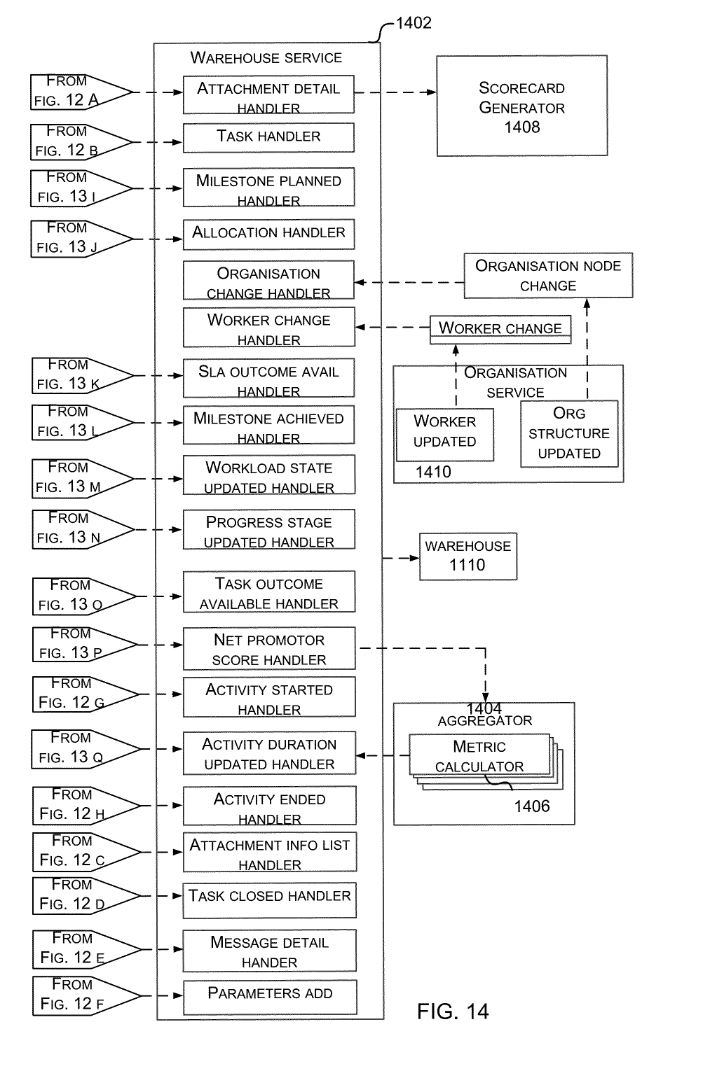

FIG. 13 shows a plurality of calculators 1302-1306 which take data items from the bus and generate further data items 1308-1315. Most of these data items (items 1308-1314) are then output to the warehouse service 1402 shown in FIG. 14. One of the data items (item 1315) is fed back from one calculator 1305 to another calculator 1306. FIG. 13 also shows two other modules: a child task propagator 1316 and a milestone detector 1318. The child task propagator 1316 propagates allocations from a parent task to child tasks (sub-module 1320) and also propagates commit states from a parent task to child tasks (sub-module 1322). The milestone detector 1318 generates milestone achieved data items based on data items retrieved from the bus: activity allocations 1218, activity ended data items 1214 and activity started data items 1215.

In addition to showing the warehouse service 1402, FIG. 14 also shows an aggregation service (or aggregator module) 1404 which comprises a plurality of metric calculators 1406. As shown in FIG. 14, the aggregation service 1404 takes data items from the warehouse service 1402, calculates metrics in the metric calculators 1406 and passes calculated metrics back to the warehouse service.

FIG. 14 also shows a score card generator module 1408 which uses data from the warehouse service 1404 and also an organizational service 1410 which enables changes to be made to the organizational structure and enables workers to be added to the system.

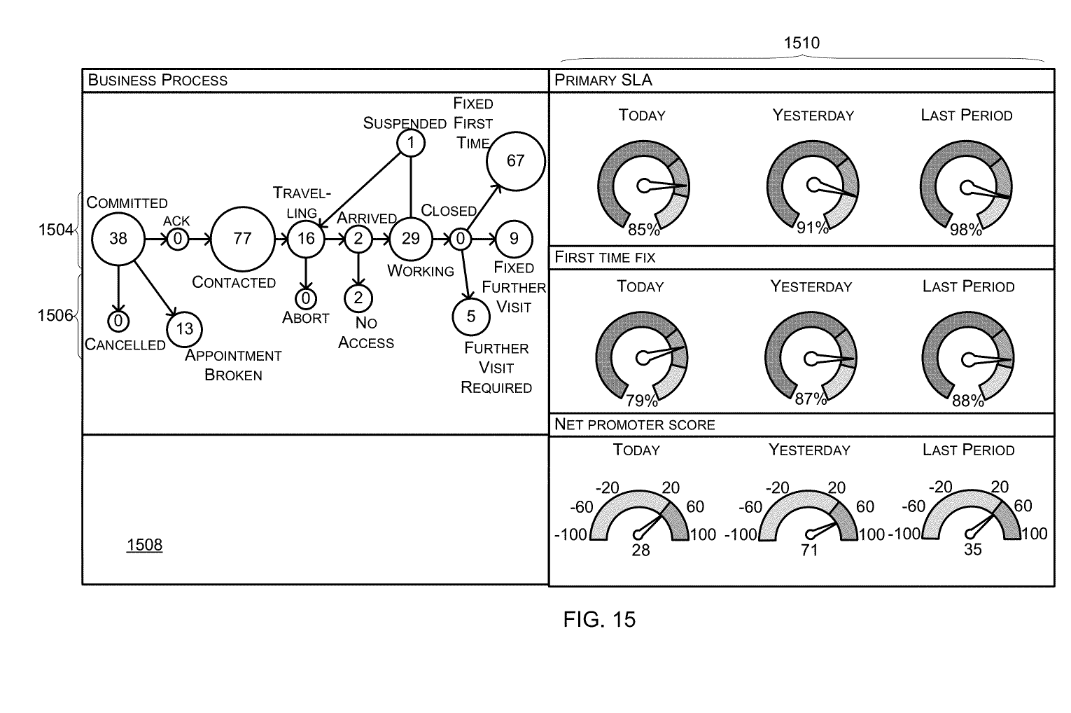

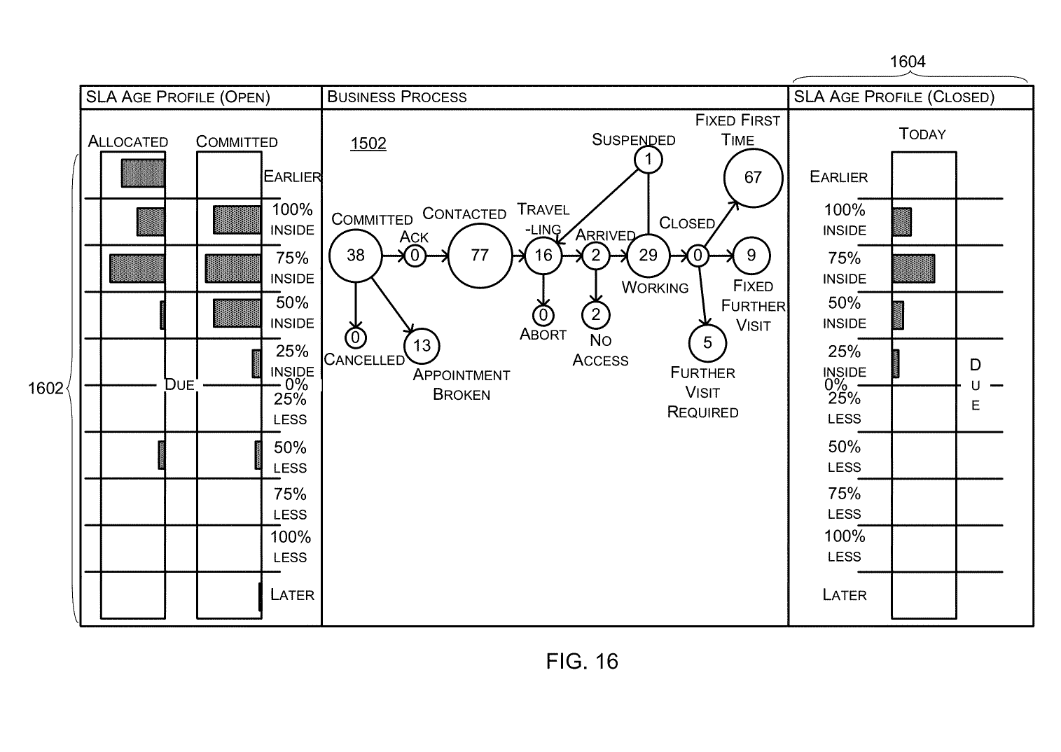

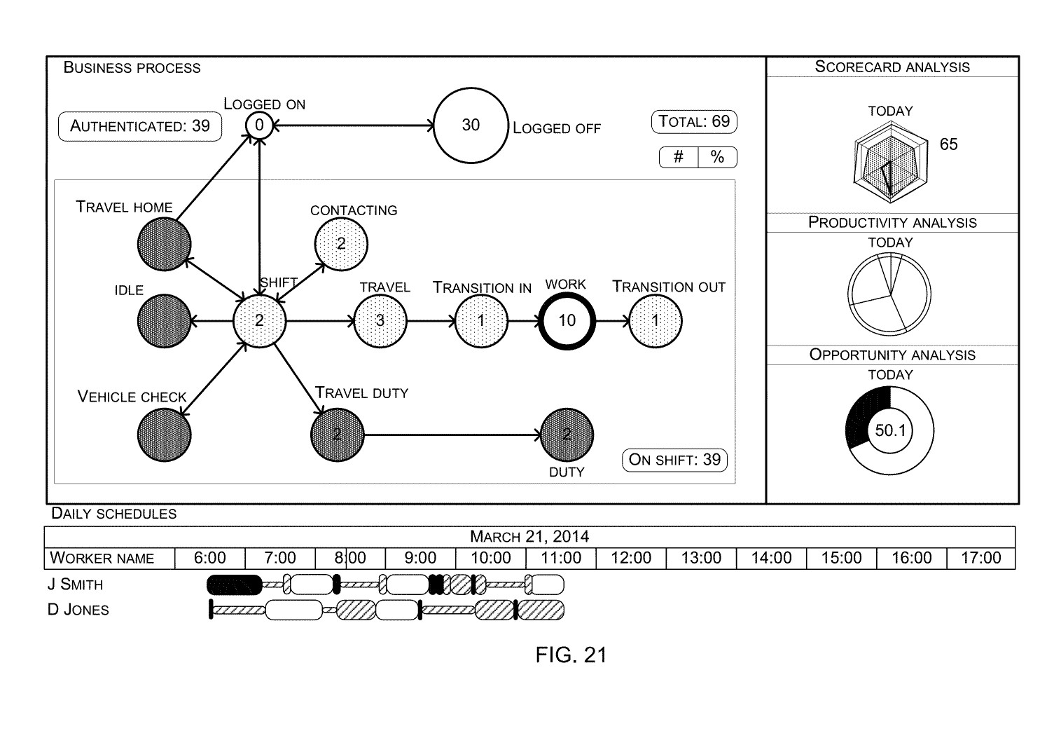

As well as providing the field-worker's score card (e.g. as shown in FIG. 3), the systems and methods described herein may also provide other data, such as a series of further single screen presentations within the GUI which each represent a different view (or perspective) of the business activity and many of which provide real-time information. For example, the GUI may provide one or more of the following additional single screens:
A task perspective (as shown in FIG. 15) which provides a real-time display of the stage that tasks are at any time. Examples of the stages that a task may be at are committed, acknowledged, contacted, cancelled, appointment broken, fixed on first visit, fixed on further visit, needs further visit, etc.
A resource perspective (as shown in FIG. 21) which provides a real-time display of the activities being undertaken by all field-based workers. For example, it may show the number of workers currently on shift (39 in the example shown), idle, performing vehicle checks, travelling home, logged off, etc.
A plan perspective which provides a real-time display of progress against plan in terms of cumulative tasks completed and a comparison of the duration of work activities associated with each task with the aim of feeding back information in order to refine future planning cycles, whether manual or automated. As the system stores a record of the expected time for each activity (or activity type), it can display in single screen data on the number of tasks which are within the expected time and the number of tasks are currently over-running. As the data is provided in real-time, a manager can monitor this screen and provide real-time assistance to field-based workers who are engaged in a task which is over-running.
A SLA perspective (as shown in FIG. 16) which provides data on whether SLAs are being met or likely to be met. An organization may have a large number (e.g. hundreds) of different SLAs and these are all aggregated together within the single screen using analysis of the age of a task compared to its due date and time (according to the SLA which relates to the task). In an example, the single screen may show the number of open (i.e. incomplete) tasks against their due date in terms of percentages 1602, e.g. if a task is opened and due in 10 days time according to its SLA, 100% corresponds to 10 days. If in 5 days time it is still open, the task will show as being 50% before its due date (50%=5/10*100). If in 11 days from the opening it still has not been completed, the task will show as being 10% after its due date (10%=1/10*100). Similar data may also be shown 1604 for closed tasks.

Each of these different perspective single screens may be presented in the form of a state diagram 1502 which comprises a prime path 1504 (which tasks would normally follow) and an exceptions path 1506 (for abnormal events, such as stages ‘cancelled’, ‘appointment broken’ and ‘needs further visit’). As described above, the data may be represented in real-time, although in various examples there may be rules applied to moderate the real-time data. For example, in the resource perspective, a field-based worker may only be shown as ‘idle’ if they have been in the idle state for more than a minimum period of time (e.g. 15 minutes) and prior to that they may be shown as being ‘on shift’. This moderation assists in highlighting exceptions to viewers of the GUI and filters out the normal activities from those activities which might otherwise be seen as anomalies. The data that is displayed within a single perspective screen may be for all field-based workers or the GUI may provide the ability to select a (proper) subset of the organization and then the perspectives relate only to the selected subset. A user may also be able to filter the data which is shown in a perspective by other criteria (e.g. field-based worker, client, SLA, etc.).

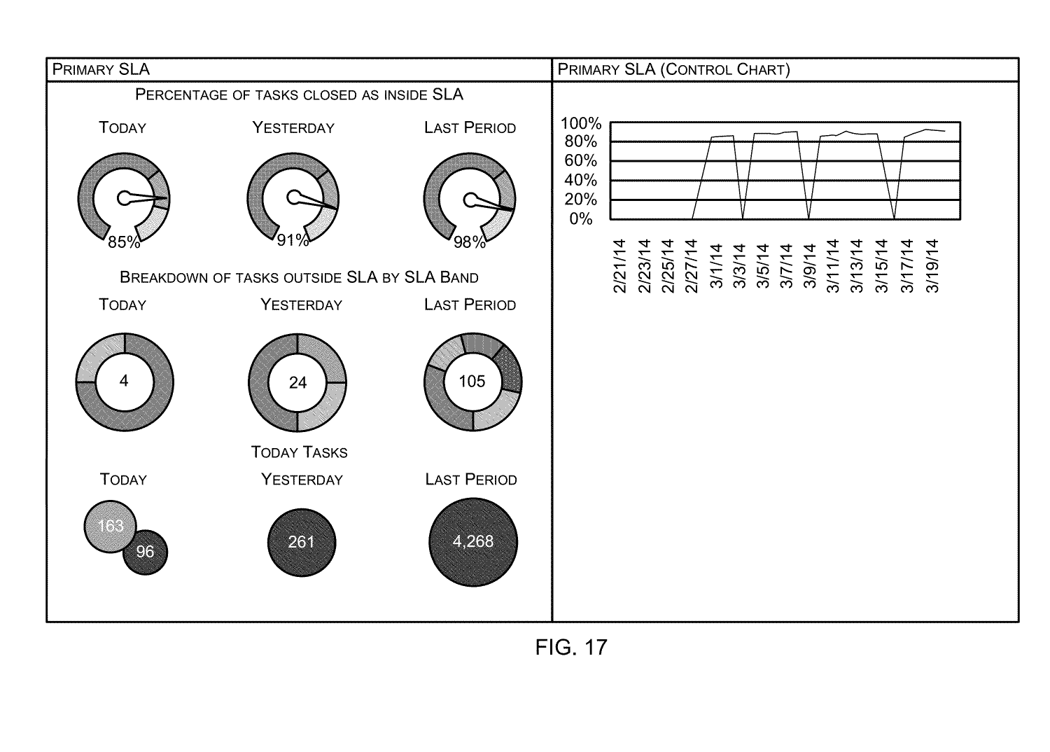

In each of the perspective screens, a user may be able to click on elements to obtain more detailed information 1508 within the same screen (e.g. which field-based workers are currently in an idle state, which are the tasks which are currently over-running, etc.). In various examples, the user may be able to view the data on a map (e.g. to identify where the field-workers who are idle are or where the field-workers with over-running travel activity are, which may indicate that there is traffic congestion). Dials or graphs 1510 may show comparisons of performance for different time periods (e.g. today, yesterday, last month, etc.). By clicking on these dials 1510, further detail may be available through additional screens (e.g. as shown in FIGS. 17-19) within the GUI.

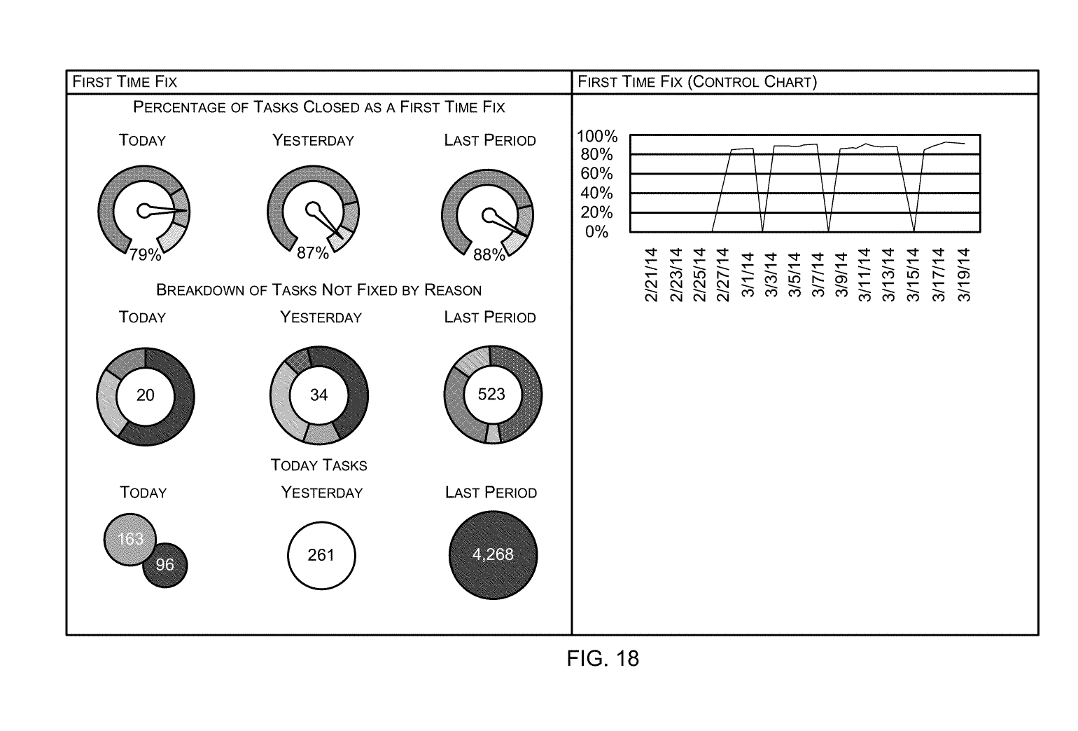

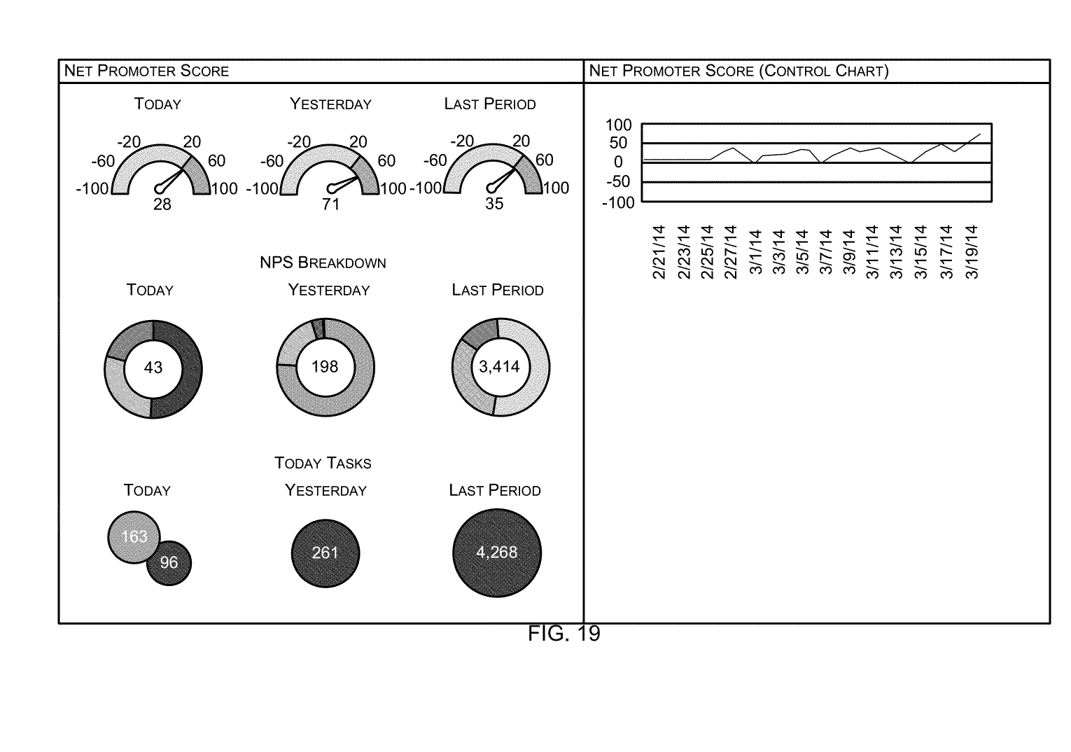

FIGS. 17-19 each show a single screen within the GUI, with one screen corresponding to each set of three dials 1510 in FIG. 15. FIG. 17 shows additional information relating to the primary SLA (i.e. the uppermost set of dials 1510 in FIG. 15), FIG. 18 shows additional information relating to the first time fix rate (i.e. the middle set of dials 1510 in FIG. 15) and FIG. 19 shows additional information relating to the NPS (i.e. the bottom set of dials 1510 in FIG. 15). Each of the additional screens have the same layout with additional information about the number of tasks to which the data relates on the left hand side of the screen and graphs showing trends on the right hand side. There is a section for additional detail which is shown if a user clicks on controls within the screen (e.g. in a similar manner to the extra detail sections 1508 in FIGS. 15 and 16.

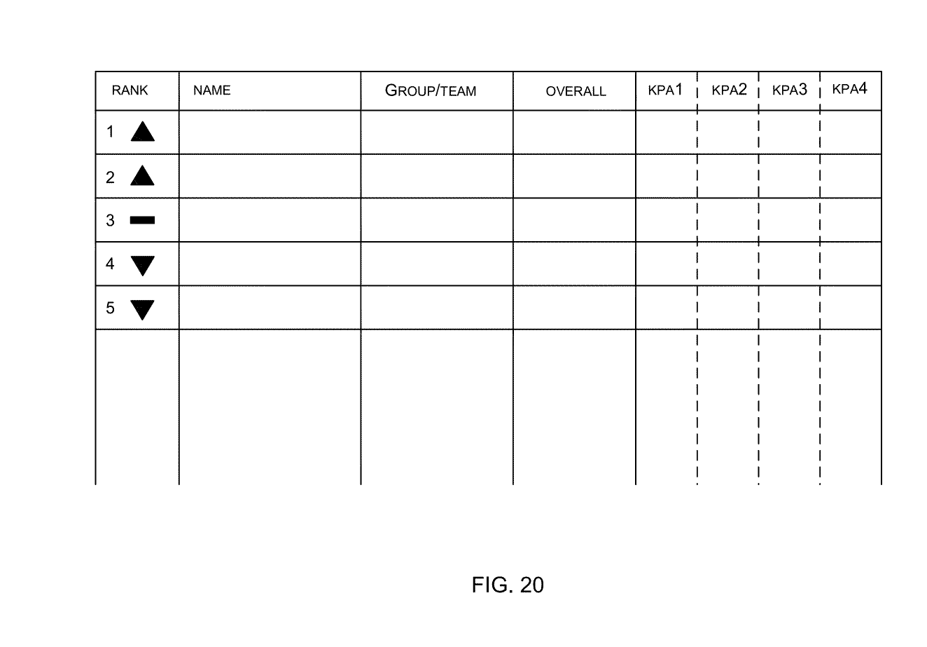

Having generated scores for field-based workers as described above (e.g. an overall score and scores for each KPA), these scores may be used to generate a league table of field-based workers as shown in FIG. 20. FIG. 20 shows a detailed league table which ranks field-based workers according to their overall score but additionally shows and color codes the scores for each KPA. It will be appreciated that in further examples, a league table may only show a subset of the information shown in FIG. 20.

The systems and methods described herein are worker-centric and are arranged to encourage desired behaviors, rather than simply satisfying task-based metrics. For example, having a performance metric relating to the number of times a task is resolved in the first visit may encourage a field-based worker to replace all possible parts that might be causing a fault in that visit, and so provide the highest chance of resolving the problem in one visit. Whilst this may resolve the problem, it may result in inefficiencies as parts may be replaced unnecessarily and this metric therefore does not encourage a field-worker to spend time diagnosing the real cause of a fault condition.

A standard task-based approach may be considered to provide a top-down approach and a top-down view of how a business and its field-based workers are performing (e.g. through visibility of milestones achieved). The methods and system described herein provide a bottom-up view of the business (which provides an employee performance dimension) as well as the top-down view (through the generated milestone data and/or the different perspective views). The bottom-up approach allows analysis of the patterns of behaviors of individual employees and provides a means to drive and measure operational improvements and efficiencies.

The systems and methods may enable overall service delivery and field-based workforce performance to be improved. They increase management visibility without introducing a significant data entry burden on the field-workers themselves. In fact, the systems and methods described herein may eliminate time-consuming preparation of manual timesheets by field-based workers, thereby increasing their efficiency. As time (e.g. the time of field-based workers) may one of the largest costs to a business, by increasing the efficiency of the field-based workers (e.g. even by gaining an extra 30 minutes of productive time per worker per day), the costs to the business can be reduced significantly.

Whilst the methods and systems are described above with reference to examples of particular types of task-driven field-based workers, the methods and systems may be applied to task-driven field-based workers in other sectors (e.g. healthcare, retail, etc.). Although many of the examples shown and described above relate to field-based service engineers, this is just one example of a sector in which the systems and methods described herein may be used.

The term ‘computer’ is used herein to refer to any device with processing capability such that it can execute instructions. Those skilled in the art will realize that such processing capabilities are incorporated into many different devices and therefore the term ‘computer’ includes PCs, servers, mobile telephones, personal digital assistants and many other devices.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

Any range or device value given herein may be extended or altered without losing the effect sought, as will be apparent to the skilled person.

It will be understood that the benefits and advantages described above may relate to one embodiment or may relate to several embodiments. The embodiments are not limited to those that solve any or all of the stated problems or those that have any or all of the stated benefits and advantages.

Any reference to ‘an’ item refers to one or more of those items. The term ‘comprising’ is used herein to mean including the method blocks or elements identified, but that such blocks or elements do not comprise an exclusive list and a method or apparatus may contain additional blocks or elements.

The steps of the methods described herein may be carried out in any suitable order, or simultaneously where appropriate. Additionally, individual blocks may be deleted from any of the methods without departing from the spirit and scope of the subject matter described herein. Aspects of any of the examples described above may be combined with aspects of any of the other examples described to form further examples without losing the effect sought.

It will be understood that the above description of a preferred embodiment is given by way of example only and that various modifications may be made by those skilled in the art. Although various embodiments have been described above with a certain degree of particularity, or with reference to one or more individual embodiments, those skilled in the art could make numerous alterations to the disclosed embodiments without departing from the spirit or scope of this invention.

1. A system for managing field-based workers comprising:
a component running on a mobile device and arranged to present an activity-based workflow to a field-based worker and to transmit one or more activity transactions to an activity processing engine at a transition point in the workflow, an activity transaction including at least one of a start and end time, at least one of a start and end location data, and an activity code;
an activity processing engine arranged to receive activity transactions from the mobile device and to process the transactions to generate one or more milestones and to analyze data received to generate one or more behavioral scores,
wherein the activity processing engine is further arranged to generate a graphical user interface which presents the behavioral scores for a particular shift performed by a field-based worker along with aggregated scores for a plurality of shifts.

2. The system according to claim 1, wherein the component comprises a hybrid mobile application running on a mobile device.

3. The system according to claim 2, wherein the location data comprises location data for the mobile device.

4. The system according to claim 1, wherein the component is arranged to transmit the activity transactions in real time to the activity processing engine.

5. The system according to claim 1, wherein the activity processing engine is arranged to generate a graphical user interface which presents the behavioral scores for a particular shift performed by a field-based worker along with aggregated scores for a plurality of shifts as a single screen within the graphical user interface.

6. The system according to claim 5, wherein the single screen comprises:
an overall single score for the particular shift;
a graph of the overall single score for a plurality of previous shifts; and
a graphical representation of a normalized score for each of a plurality of key performance areas, wherein the overall single score comprises a weighted average of the normalized scores for the key performance areas.

7. The system according to claim 6, wherein the single screen further comprises one or more of:
a map overlaying task and activity data for the particular shift;
a detailed activity record in which variation from planned durations is marked; and
shift analysis in which any deviations from expected behaviors at a start or end of the particular shift are marked.

8. The system according to claim 1, wherein the behavioral scores for a particular shift comprise an overall score for the particular shift.

9. The system according to claim 1, wherein the behavioral scores for a particular shift comprise a normalized score for each of a plurality of key performance areas and an overall score for the particular shift, the overall score comprising a weighted average of the normalized scores for each of the key performance areas.

10. The system according to claim 1, wherein the activity processing engine is arranged to analyze data received to generate one or more behavioral scores by comparing a time or duration of an activity to an expected time for the activity to identify a difference and to represent the difference graphically within the graphical user interface.

11. The system according to claim 1, wherein the activity processing engine comprises:
a plurality of calculators arranged to generate the one or more milestones; and
an aggregation service arranged to use data generated by the calculators to generate the one or more behavioral scores.

12. The system according to claim 1, wherein the activity processing engine is further arranged to analyze data received from a plurality of components in real time, each component corresponding to a different field-based worker, and to generate a graphical user interface which presents current activities of a plurality of field-based workers.

13. A method of managing field-based workers comprising:
receiving a plurality of activity transactions at an activity processing engine from a mobile device, the generation of activity transactions being triggered by a transition point in an activity-based workflow and an activity transaction including at least one of a start and end time, at least one of a start and end location data, and an activity code;
processing the transactions to generate one or more milestones;
analyzing the transactions to generate one or more behavioral scores; and
generating a graphical user interface comprising the behavioral scores for a particular shift performed by a field-based worker and aggregated scores for a plurality of shifts.

14. The method according to claim 13, further comprising:
receiving a plurality of activity transactions at the activity processing engine from a plurality of mobile devices, each mobile device corresponding to a different field-based worker,
and wherein generating a graphical user interface comprising the behavioral scores for a particular shift performed by a field-based worker and aggregated scores for a plurality of shifts comprises:
generating a graphical user interface comprising a single screen score card for each field-based worker, the single screen score card showing the behavioral scores for a particular shift performed by the field-based worker and aggregated scores for a plurality of shifts completed by the field-based worker.

15. The method according to claim 13, wherein analyzing the transactions to generate one or more behavioral scores comprises, for a shift:
analyzing the transactions to generate a normalized score for a plurality of key performance indicators;
generating a normalized score for each of a plurality of key performance areas from one or more normalized scores for key performance indicators; and
generating a single overall score for the shift using a weighted average of the normalized scores for the plurality of key performance areas.

16. The method according to claim 13, wherein analyzing the transactions to generate one or more behavioral scores comprises comparing a time or duration of an activity to an expected time for the activity.

17. The method according to claim 13, wherein the transactions are analyzed at an end of a field-worker's shift to generate one or more behavioral scores for the shift.

18. The method according to claim 13, further comprising:
analyzing transactions received from a plurality of mobile devices in real time, each mobile device corresponding to a different field-based worker; and
generating a graphical user interface showing real time activity data for a plurality of field-based workers.

19. A method according to claim 13, further comprising:
presenting an activity-based workflow to a field-based worker on a mobile device; and
transmitting one or more activity transactions from the mobile device to the activity processing engine at each transition point in the workflow.

20. A system for managing field-based workers comprising:
an activity processing engine arranged to receive activity transactions from a mobile device and to process the transactions to generate one or more milestones and to analyze data received to generate one or more behavioral scores,
wherein the generation of activity transactions is triggered by a transition point in an activity-based workflow and an activity transaction includes at least one of a start and end time, at least one of a start and end location data, and an activity code;
wherein the activity processing engine is further arranged to generate a graphical user interface which presents the behavioral scores for a particular shift performed by a field-based worker along with aggregated scores for a plurality of shifts in a single screen.
